(19) United States
(12) Patent Application Publication
(10) Pub. No.: US 2024/0005203 A1
(43) Pub. Date: Jan. 4, 2024

(54) METHOD OF AND SYSTEM FOR ADAPTING MULTIPLE TRAINED MACHINE LEARNING MODELS ON UNLABELLED DATASET

(71) Applicant: IMAGIA CYBERNETICS INC., Montréel (CA)

(72) Inventors: Florent CHANDELIER, LERY (CA); Lisa DI-JORIO, Montréel (CA); Mohammad HAVAEI, Montréel (CA); Phililppe LACAILLE, Montréel (CA); Qicheng LAO, Montréel (CA); Xiang JIANG, Montréel (CA)

(73) Assignee: IMAGIA CYBERNETICS INC., Montréel, QC (CA)

(21) Appl. No.: 18/038,178

(22) PCT Filed: Nov. 19, 2021
(86) PCT No.: PCT/IB2021/060764

§ 371 Date: May 22, 2023

Related U.S. Application Data
(60) Provisional application No. 63/116,392, filed on Nov. 20, 2020.

(51) Int. Cl. G06N 20/00

(52) U.S. Cl. CPC G06N 20/00

(57) ABSTRACT

There is provided a method and system for training and adapting a set of trained models each comprising a common feature extractor by using an unlabelled training dataset to thereby obtain an updated common feature extractor. The set of trained models have been trained for a common prediction task on a labelled training dataset is obtained. An unlabelled training dataset is obtained. The set of trained models is trained by using the unlabelled training dataset by generating, using the common feature extractor, a set of feature vectors for the unlabelled training dataset, and generating, using the set of trained models, a set of predictions, the set of predictions comprising a respective prediction for each of the set of feature vectors. During training, the common feature extractor is updated by maximizing, for each given trained model, a mutual information between the set of feature vectors and the respective predictions.

### CROSS-REFERENCE TO RELATED APPLICATIONS

The present application claims priority from U.S. Provisional Patent Application, Ser. No. 63/116,392, filed on Nov. 20, 2021, the content of which is incorporated herein by reference.

### FIELD

The present technology relates to machine learning (ML) in general and more specifically to methods and systems for training and adapting a set of trained machine learning models each comprising a common feature extractor on an unlabelled training dataset to thereby obtain an updated common feature extractor.

### BACKGROUND

Mutual information (MI) maximization has been shown as a promising approach in unsupervised learning, as manifested in discriminative clustering and unsupervised representation learning. Recently, it has also been applied to unsupervised domain adaptation (UDA), achieving new state-of-the-art performance even in the more restricted context of hypothesis transfer learning (HTL), where the knowledge transfer from a source domain to a target domain is achieved solely through hypotheses. Hypothesis transfer has the notable privacy-preserving property that respects the privacy of the source domain by eliminating the need to access the source data while transferring knowledge to the target domain and is favored by both theoretical analysis and many empirical applications.

However, HTL has been mostly explored in the supervised learning setting where the target labels are available.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

One or more embodiments of the present technology have been developed based on developers' appreciation of remaining problems in unsupervised transfer learning of machine learning models based on mutual information maximization, where a gap remains between transfer learning of the source machine learning models and unsupervised domain adaptation of the source machine learning models.

Developers have proposed to transfer knowledge from a set of source hypotheses (i.e., source machine learning models) learned from a source domain (i.e., labelled training dataset) to a corresponding set of target hypotheses (i.e., target machine learning models) by means of mutual information (MI) maximization on the unlabelled target data.

Developers have appreciated that the employment of multiple hypotheses (i.e., multiple machine learning models) is especially relevant to domain adaptation with out-of-distribution examples and has a pronounced impact on the uncertainty calibration and adaptation/transfer performance.

Further, developers have appreciated the limitations of multiple independent MI maximization where different target hypotheses (i.e., different target machine learning models) are optimized in an unconstrained manner due to the unsupervised adaptation procedure, resulting in undesirable disagreements on the target label predictions as well as instability in the optimization process.

Developer(s) have also appreciated that regularization techniques based on minimization of a dissimilarity measure of the predictions of the source machine learning models may be used to align the source machine learning models in a way such that the uncertainty manifested through different source machine learning models is taken into account while the undesirable disagreements are marginalized out during adaptation.

Thus, one or more embodiments of the present technology are directed to methods and systems for adapting a set of trained machine learning models having been trained on a labelled dataset by training the set of trained machine learning models on an unlabelled dataset using mutual information maximization and prediction disparity regularization.

One or more embodiments of the present technology may be used in the context of continual learning and decentralized federated learning. For example, the present technology may enable parties to collaborate and contribute to the improvement of a feature extractor, while also specializing the feature extractor on local datasets (which are private in the context of the federated learning). The present technology may be used to identify a feature extractor architecture and/or type that is invariant to different types of domains, which may be used in fields such as, but not limited to, radiomics. For example, in radiomics, the present technology may be used to adapt a pre-trained machine learning model having been trained on a dataset associated with a particular imaging modality (e.g. computational tomography (CT) scan) to a dataset associated with another imaging modality (e.g., magnetic resonance imaging (MRI)), thus generalizing its feature extraction capabilities. Additionally, a feature extractor having been trained according to one or more embodiments of the present technology may be used to extract features from data to be used in the design and development of a radiomics signature, to be further used for example during clinical & patient management (e.g. predicting patient outcome and disease progression, clinical diagnosis, personalized therapy selection) and/or during clinical trial design & development (e.g. patient identification, and patient monitoring for a given endpoint).

In accordance with a broad aspect of the present technology, there is provided a method for training a set of trained models each including a common feature extractor by using an unlabelled training dataset to thereby obtain an updated common feature extractor. The method is executed by at least one processing device. The method comprises: obtaining the set of trained models, each trained model of the set of trained models having the common feature extractor, each trained model of the set of trained models having been trained for a common prediction task during a supervised training phase on a labelled training dataset, obtaining the unlabelled training dataset, and training, for the common prediction task, the set of trained models by using the obtained unlabelled training dataset to thereby obtain the updated common feature extractor. The training includes: generating, using the common feature extractor of the set of trained models, a set of feature vectors for at least a portion of the unlabelled training dataset, generating, using the set of trained models, a set of predictions, the set of predictions including a respective prediction for each of the set of feature vectors, and updating the common feature extractor, the updating including: maximizing, for each given trained model of the set of trained models, a mutual information between the set of feature vectors and the respective predictions generated by the set of trained models.

In one or more embodiments of the method, the method further comprises providing, using the updated common feature extractor, the final trained model.

In one or more embodiments of the method, the common prediction task comprises one of: a regression task, and a classification task.

In one or more embodiments of the method, said updating of the common feature extractor further comprises: minimizing a dissimilarity measure between at least a given prediction of the set of predictions and at least one other given prediction of the set of predictions of the set of trained models.

In one or more embodiments of the method, the method further comprises, prior to said obtaining of the set of trained models: obtaining the labelled training dataset, initializing, based on a different respective condition, each initial model of a set of initial models for the common prediction task, each initial model includes an initial common feature extractor, and training the set of initial models for the common prediction task during the supervised training phase on the labelled training dataset to obtain the set of trained models, each trained model of the set of trained models includes the common feature extractor.

In one or more embodiments of the method, said training of the set of initial models for the common prediction task during the supervised training phase on the labelled training dataset to obtain the set of trained models comprises: generating, using the set of initial models, a set of initial predictions for the labelled training dataset, and updating at least a portion of each of the set of initial models to obtain the set of trained models, the updating includes: determining a respective loss for each of the set of initial predictions to obtain a set of losses.

In one or more embodiments of the method, said updating of at least the portion of each of the set of initial models to obtain the set of trained models further comprises:

determining an average loss based on the set of losses, and backpropagating the average loss to the at least the portion of the set of initial models

In one or more embodiments of the method, the labelled training dataset is associated with a first type of domain representation of a set of objects, the unlabelled training dataset is associated with a second type of domain representation of at least a portion of the set of objects.

In one or more embodiments of the method, the labelled training dataset comprises labelled images, and the unlabelled training dataset comprises unlabelled images.

In one or more embodiments of the method, the labelled training dataset has been acquired using a first type of device, and the unlabelled training dataset has been acquired using a second type of device.

In one or more embodiments of the method, the method further comprises using the updated common feature extractor to extract features from data in a radiomics process.

In one or more embodiments of the method, the method further comprises using the updated common feature extractor to train a further model for a further prediction task, the further prediction task being different from the common prediction task.

In one or more embodiments of the method, the method further comprises using at least the updated common feature extractor to locally train a subsequent model for a further prediction local task, the further local prediction task being different from the common prediction task.

In one or more embodiments of the method, the at least one processing device comprises a server and a client device, the server performs the supervised training phase of the set of trained models on the labelled training dataset for the common prediction task and the client device performs the training of the set of trained models by using the obtained unlabelled training dataset to thereby obtain the updated common feature extractor.

In one or more embodiments of the method, the at least one processing device is part of a decentralized and continual learning system comprising at least one further processing device.

In accordance with a broad aspect of the present technology, there is provided a system for training a set of trained models each including a common feature extractor by using an unlabelled training dataset to thereby obtain an updated common feature extractor. The system comprises: a processor, and a non-transitory storage medium operatively connected to the processor, the non-transitory storage medium including computer-readable instructions. The processor, upon executing the computer-readable instructions, is configured for: obtaining the set of trained models, each trained model of the set of trained models having the common feature extractor, each trained model of the set of trained models having been trained for a common prediction task during a supervised training phase on a labelled training dataset, obtaining the unlabelled training dataset, training, for the common prediction task, the set of trained models by using the obtained unlabelled training dataset to thereby obtain the updated common feature extractor. The training includes: generating, using the common feature extractor of the set of trained models, a set of feature vectors for at least a portion of the unlabelled training dataset, generating, using the set of trained models, a set of predictions, the set of predictions includes a respective prediction for each of the set of feature vectors, and updating the common feature extractor, the updating includes: maximizing, for each given trained model of the set of trained models, a mutual information between the set of feature vectors and the respective predictions generated by the set of trained models.

In one or more embodiments of the system, the processor is further configured for: providing, using the updated common feature extractors, a final trained model.

In one or more embodiments of the system, the common prediction task comprises one of: a regression task, and a classification task.

In one or more embodiments of the system, said updating of the common feature extractor further comprises: minimizing a dissimilarity measure between at least a given prediction of the set of predictions and at least one other given prediction of the set of predictions of the set of trained models.

In one or more embodiments of the system, the processor is further configured for, prior to said obtaining of the set of trained models: obtaining the labelled training dataset, initializing, based on a different respective condition, each initial model of a set of initial models for the common prediction task, each initial model includes an initial common feature extractor, and training the set of initial models for the common prediction task during the supervised training phase on the labelled training dataset to obtain the set of trained models, each trained model of the set of trained models includes the common feature extractor.

In one or more embodiments of the system, said training of the set of initial models for the common prediction task during the supervised training phase on the labelled training dataset to obtain the set of trained models comprises: generating, using the set of initial models, a set of initial predictions for the labelled training dataset, and updating at least a portion of each of the set of initial models to obtain the set of trained models, the updating includes: determining a respective loss for each of the set of initial predictions to obtain a set of losses.

In one or more embodiments of the system, said updating of at least the portion of each of the set of initial models to obtain the set of trained models further comprises: determining an average loss based on the set of losses, and backpropagating the average loss to the at least the portion of the set of initial models

In one or more embodiments of the system, the labelled training dataset is associated with a first type of domain representation of a set of objects, the unlabelled training dataset is associated with a second type of domain representation of at least a portion of the set of objects.

In one or more embodiments of the system, the labelled training dataset comprises labelled images, and the unlabelled training dataset comprises unlabelled images.

In one or more embodiments of the system, the labelled training dataset has been acquired using a first type of device, and the unlabelled training dataset has been acquired using a second type of device.

In one or more embodiments of the system, the processor is further configured for using the updated common feature extractor to extract features from data in a radiomics process.

In one or more embodiments of the system, the system comprises a further processor connected to the processor, and the further processor performs the supervised training phase of the set of trained models on the labelled training dataset for the common prediction task.

In one or more embodiments of the system, the system is further configured for using the updated common feature extractor to train a further model for a further prediction task, the further prediction task being different from the common prediction task.

In one or more embodiments of the system, the system is further configured for using at least the updated common feature extractor to locally train a subsequent model for a further local prediction task, the further local prediction task being different from the common prediction task.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drives, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the present technology,” unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an electronic device in accordance with one or more non-limiting embodiments of the present technology.

FIG. 2 depicts a schematic diagram of a system in accordance with one or more non-limiting embodiments of the present technology.

FIG. 3 and FIG. 4 depict a schematic diagram of a hypothesis disparity regularized mutual information maximization (HDMI) training procedure in accordance with one or more non-limiting embodiments of the present technology.

FIG. 5 depicts a flow chart of a method of training a first set of trained models each comprising a common feature extractor by using an unlabelled training dataset to thereby obtain an updated common feature extractor, the method being depicted in accordance with one or more non-limiting embodiments of the present technology.

FIG. 6 depicts a plot showing that the hypothesis disparity regularization stabilizes the optimization for MI maximization (on A→D, Office-31) in accordance with one or more non-limiting embodiments of the present technology.

FIG. 7 depicts a plot showing that the target error analysis of HDMI (with three hypotheses) preserves more transferable source knowledge, as compared with using MI maximization alone (on A→D, Office-31) in accordance with one or more non-limiting embodiments of the present technology.

FIG. 8 depicts a plot showing (a) the t-SNE visualization comparing the target predictions from different source hypotheses, (b-d) the disagreements between different hypotheses' predictions (%), where yⁱ denotes the predictions of hypothesis hi and y denotes the ground-truth labels, where all plot figures are on A→D, Office-31 in accordance with one or more non-limiting embodiments of the present technology.

FIG. 9 depicts a plot showing a reliability diagram of the target domain after transfer (with class 11 as the positive class) in accordance with one or more non-limiting embodiments of the present technology.

FIG. 10 depicts a plot showing a KL divergence between hypotheses on A→D, Office-31, where the columns represent p and the rows represent q in KL[p ∥ q] in accordance with one or more non-limiting embodiments of the present technology.

FIG. 11 depicts a plot showing a reliability diagram of the target domain when the model is only trained on the source (with class 6 selected as the positive class) in accordance with one or more non-limiting embodiments of the present technology.

FIG. 12 depicts a plot showing a reliability diagram of the target domain after hypothesis transfer (with class 11 selected as the positive class) in accordance with one or more non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processing device”, “processor” or a “graphics processing unit”, may be provided through the use of dedicated hardware as well as hardware capable of executing software in association with appropriate software. When provided by a processing device, the functions may be provided by a single dedicated processor, by a single shared processor, or by a plurality of individual processors, some of which may be shared. In one or more non-limiting embodiments of the present technology, the processing device may be a general-purpose processor, such as a central processing unit (CPU) or a processor dedicated to a specific purpose, such as a graphics processing unit (GPU). Moreover, explicit use of the term “processing device”, “processing unit”, “processor”, “control unit” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Electronic Device

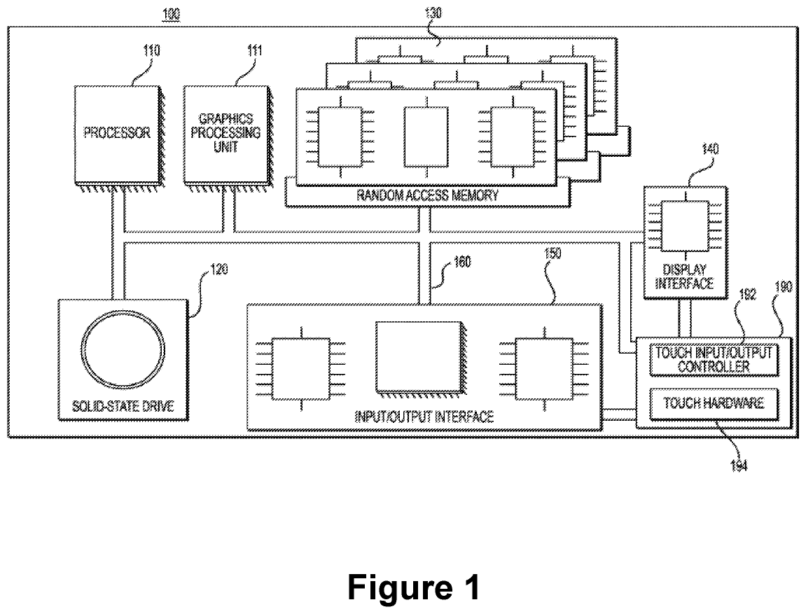

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111 for adapting a set of trained machine learning models having been trained on a labelled dataset by training the set of trained machine learning models on an unlabelled dataset using mutual information maximization and prediction disparity regularization. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

### System

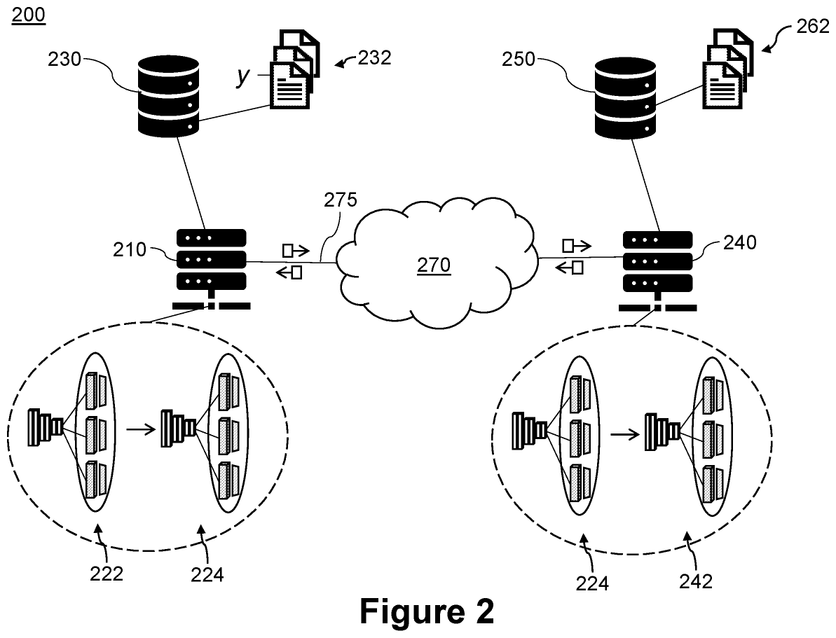

Referring to FIG. 2, there is shown a schematic diagram of a communication system 200, which will be referred to as the system 200, the system 200 being suitable for implementing one or more non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a first server 210 connected to a first database 230, and a second server 240 connected to a second database 250, the first server 210 and the second server 240 being communicatively coupled over a communications network 270.

### First Server

The first server 210 is configured to inter alia: (i) obtain a set of initial machine learning (ML) models 222 to train for performing a common prediction task; (ii) obtain a labelled training dataset 232; (iii) train the set of initial ML models 222 to perform the common prediction task by using the labelled training dataset to obtain a first set of trained ML models 224; and (iv) provide the set of first set of trained ML models 224.

How the first server 210 is configured to do so will be explained in more detail herein below.

It will be appreciated that the first server 210 can be implemented as a conventional computer server and may comprise at least some of the features of the electronic device 100 shown in FIG. 1. In a non-limiting example of one or more embodiments of the present technology, the first server 210 is implemented as a server running an operating system (OS). Needless to say that the first server 210 may be implemented in any suitable hardware and/or software and/or firmware or a combination thereof. In the disclosed non-limiting embodiment of present technology, the first server 210 is a single server. In one or more alternative non-limiting embodiments of the present technology, the functionality of the first server 210 may be distributed and may be implemented via multiple servers (not shown).

The implementation of the first server 210 is well known to the person skilled in the art. However, the first server 210 comprises a communication interface (not shown) configured to communicate with various entities (such as the first database 230, second server 240, the second database 250 and other devices potentially coupled to the first server 210) via the communication network 270. The first server 210 comprises at least one processing device (e.g., the processor 110 or the GPU 111 of the electronic device 100) operationally connected with the communication interface(s) and structured and configured to execute various processes to be described herein.

The first server 210 has access to a set of initial ML models 222. The set of initial ML models 222 comprise at least two ML models. It will be appreciated that the set of initial ML models 222 may comprise three, four, five or more ML models without departing from the scope of the present technology. As depicted in FIG. 2, the set of initial models 222 comprises three ML models (not separately numbered).

In one or more embodiments, the set of initial ML models 222 may have been previously initialized, transferred for storage to the first database 230 and the first server 210 may obtain the set of initial ML models 222 from the first database 230, or may obtain the set of initial ML models 222 from an electronic device connected to the communication network 270.

In one or more other embodiments, the first server 210 obtains the set of initial ML models 222 by performing a model initialization procedure to initialize the model parameters and model hyperparameters of the set of initial ML models 222.

The model parameters are configuration variables of a machine learning model and which are estimated or learned from training data, i.e., the coefficients are chosen during learning based on an optimization strategy for outputting a prediction according to a prediction task.

It will be appreciated that the model parameters of the set of initial ML models 222 depend on inter alia the type of prediction task at hand (i.e. regression or classification) as well as other characteristics that may be chosen by an operator and obtained by the first server 210. Thus, the set of initial ML models 222 each perform the same type of prediction (but may obtain different predictions outputs) for the same input data.

In one or more embodiments, the set of initial ML models 222 may be configured so as to perform a common classification task. In one or more other embodiments, the set of initial ML models 222 may be configured so as to perform a common regression task.

In one or more embodiments, the first server 210 obtains the hyperparameters in addition to the model parameters for the set of initial ML models 222. The hyperparameters are configuration variables which determine the structure of the machine learning model and how the machine learning model is trained.

In the context of the present technology, each initial ML model of the set of initial ML models 222 has an initial common feature extractor (not numbered in FIG. 2) for extracting features from input data and a respective initial prediction network (not numbered in FIG. 2) for performing respective predictions based on the extracted features. The respective prediction network may comprise one of a classification network (or classifier) and a regression network (or regressor).

The first server 210 is configured to train the set of initial ML models 222 to perform predictions on the labelled training dataset 232 to obtain a first set of trained ML models 224 or set of source ML models 224.

The first server 210 is connected to the first database 230.

### First Database

The first database 230 is directly connected to the first server 210 but, in one or more alternative implementations, the first database 230 may be communicatively coupled to the first server 210 via the communications network 270 without departing from the teachings of the present technology. Although the first database 230 is illustrated schematically herein as a single entity, it will be appreciated that the first database 230 may be configured in a distributed manner, for example, the first database 230 may have different components, each component being configured for a particular kind of retrieval therefrom or storage therein.

The first database 230 may be a structured collection of data, irrespective of its particular structure or the computer hardware on which data is stored, implemented or otherwise rendered available for use. The first database 230 may reside on the same hardware as a process that stores or makes use of the information stored in the database 230 such as the first server 210, or it may reside on separate hardware, such as on one or more other electronic devices (not shown) directly connected to the first server 210 and/or connected to the communications network 270. The database 230 may receive data from the first server 210 for storage thereof and may provide stored data to the first server 210 for use thereof.

The first database 230 is configured to inter alia: (i) store model parameters and hyperparameters of the set of initial ML models 222; (ii) store a labelled training dataset 232; and (iii) store model parameters and hyperparameters of the first set of trained ML models 224.

The labelled training dataset 232 or set of labelled training examples 232 comprises a plurality of training examples, where each labelled training example is associated with a respective label (not depicted in FIG. 2). The labelled training dataset 232 is used to train the set of initial ML models 222 to perform a common prediction task.

It will be appreciated that the nature of the labelled training dataset 232 and the number of training data is not limited and depends on the task at hand. The training dataset 232 may comprise any kind of digital file which may be processed by a machine learning model as described herein to generate predictions. In one or more embodiments, the labelled training dataset 232 includes one of: images, videos, text, and audio files. Non-limiting examples of publicly available labelled image training datasets include Office-31, Office-Home, and VisDA-C.

In one or more embodiments, the first database 230 may store ML file formats, such as .tfrecords, .csv, .npy, and .petastorm as well as the file formats used to store models, such as .pb and .pkl. The first database 230 may also store well-known file formats such as, but not limited to image file formats (e.g., .png, .jpeg), video file formats (e.g., .mp4, .mkv, etc), archive file formats (e.g., .zip, .gz, .tar, .bzip2), document file formats (e.g., .docx, .pdf, .txt) or web file formats (e.g., .html).

As a non-limiting example, the plurality of training examples may include images acquired by a medical imaging apparatus, such as an x-ray, a CT-scan, and a MRI, and the label may be indicative of a medical diagnostic (e.g., presence of metastasis or not, size or stage of a metastasis, and the like). As another non-limiting example, the plurality of training examples may include text portions (e.g., e-mails or text messages) associated with a respective class (e.g., spam or not spam).

In one or more embodiments, the labelled training dataset 232 comprises a first type of domain representation or “source” domain representation of objects associated with the set of initial ML models 222. A domain representation of a ML model represents key characteristics of the environment in which the data to train the ML model is generated. One such characteristic of a domain is a probability distribution of the training data used to train the ML model. It will be appreciated that a ML model's output in a deployment configuration is most accurate when its input comes from the same domain as the domain of the training data in the training configuration. For example, a ML model trained with data from consumer vehicles of a certain manufacturer make and model operating in a geographical region, such as a particular city, will perform the best when applied to vehicles and regions similar to those corresponding to the training data. For example, in the context of object detection, domain changes in object detection arise with variations in viewpoint, background, object appearance, scene type and illumination.

Types of domain representations will be discussed in more detail hereinbelow.

As a non-limiting example, the first type of domain representation may comprise images acquired by one type of imaging apparatus (e.g., CT-scan, X-Ray, positron emission tomography (PET) scan, single-photon emission computed tomography (SPECT), MRI apparatus, ultrasound device, functional photoacoustic microscopy (fPAM), magnetic particle imaging (MPI), optical imaging, near-infrared spectroscopy (NIRS), photoacoustic imaging, etc.) of one or more objects having similar features from which predictions can be performed (e.g., images of abdomens of different patients).

Non-limiting examples of training datasets which include multiple types of domain representations include the Office-31 dataset (three domains: Amazon, DSLR and Webcam), Office-Home dataset (four domains: Artistic images (Ar), Clip art (CI), Product images (Pr) and Real-World images (Rw)), and the VisDA-C dataset (two domains: synthetic images and real images). In one or more embodiments where the labelled training dataset 232 comprises the first type of domain representation of objects, the labelled training dataset 232 may comprise as a non-limiting example one of the domains of the Office-31 dataset, the Office-Home dataset, or the VisDA-C dataset.

It will be appreciated that the first database 230 may store other types of data such as first validation sets (not depicted), first test sets (not depicted) associated with the labelled training dataset 232 and the like.

### Second Server

The second server 240 is configured to inter alia: (i) obtain the first set of trained ML models 224; (ii) obtain an unlabelled training dataset 262; and (iii) train the first set of trained ML models 224 for the common prediction task using the unlabelled training dataset 262 to obtain a second set of trained ML models 242; and (iv) provide, using the second set of trained ML models 242, an updated common feature extractor (not depicted in FIG. 2).

It will be appreciated that the common prediction task for the first set of trained ML models 224 and the second set of trained ML models 242 corresponds to the same label space.

More specifically, during training on the unlabelled training dataset 262, the second server 240 updates only the common feature extractor of the first set of trained ML models 224 to obtain an updated common feature extractor to form the second set of trained ML models 242.

By training the first set of trained ML models 224 on the unlabelled training dataset 262 to obtain the second set of trained ML models 242, the second server 240 improves the performance in predictions of the trained ML models by performing domain adaptation.

How the second server 240 is configured to do so will be explained in more detail herein below.

In one or more embodiments, the second server 240 may be implemented in a manner similar to the first server 210. In one or more other embodiments, the second server 240 may be implemented as a different type of electronic device, such as a laptop, a smartphone, and the like.

The second server 240 may obtain the first set of trained ML models 224 from the first server 210. In one or more other embodiments, the second server 240 may obtain the first set of trained ML models 224 from the second database 250 or from another electronic device connected to the communications network 270.

It will be appreciated that the second server 240 and the first server 210 may be implemented as a single server which trains the set of initial ML models 222 on the labelled training dataset 232 to obtain the first set of trained ML models 224, and then trains the first set of trained ML models 224 on the unlabelled training dataset 262 to obtain the second set of trained ML models 242.

The second server 240 is connected to the second database 250.

It will be appreciated that the second database 250 may reside on the same hardware as a process that stores or makes use of the information stored in the second database 250 such as the second server 240, or it may reside on separate hardware, such as on one or more other electronic devices (not shown) directly connected to the second server 240 and/or connected to the communications network 270. The second database 250 may receive data from the second server 240 for storage thereof and may provide stored data to the second server 240 for use thereof. In one or more alternative embodiments, the second database 250 and the first database 230 may be implemented as a single database.

### Second Database

The second database 250 is configured to inter alia: (i) store model parameters and hyperparameters of the first set of trained ML models 224; (ii) store an unlabelled training dataset 262; and (iii) store model parameters and hyperparameters of the second set of trained ML models 242.

The unlabelled training dataset 262 or set of unlabelled training examples 262 comprises a plurality of unlabelled examples. The unlabelled training dataset 262 has the same type of data as the labelled training dataset 232, however the respective label of each unlabelled training example is unknown. The unlabelled training dataset 262 shares the same label space as the labelled training dataset 232.

The first set of trained ML models 224 has not been previously trained on the unlabelled training dataset 262.

In one or more embodiments, the unlabelled training dataset 262 comprises a second type of domain representation or “target” domain representation of objects. The second type of domain representation is different from the first type of domain representation of the labelled training dataset 232 but represents the same type of objects or concepts. The first type of domain representation and the second type of domain representation may have the same feature space, but different distributions. In one or more other embodiments, the first type and second type of domain representations may have the same feature space and the same distributions. In one or more embodiments where the unlabelled training dataset 262 comprises the second type of domain representation of objects, the unlabelled training dataset 262 may comprise as a non-limiting example another one of the respective domains of the Office-31 dataset, the Office-dataset, or the VisDA-C dataset (i.e., different from the domain representation included in the labelled training dataset 232).

It will be appreciated that in one or more alternative embodiments of the present technology, the domain representation of the labelled training dataset 232 and the unlabelled training dataset 262 may be the same, which may enable speeding up information structure of the machine learning models in some cases.

As a non-limiting example, if the first type of domain representation comprise images acquired by one type of imaging apparatus (e.g., one of CT-scan, X-Ray, PET scan, MRI apparatus, ultrasound device, etc.) of one or more objects having similar features from which predictions can be performed (e.g. images of abdomens of different patients), the second type of domain representation may comprises images of the same type of objects (e.g. images of abdomens) but acquired from a different type of imaging apparatus (e.g., another one of the CT-scan, X-Ray, PET scan, MRI apparatus, ultrasound device, etc.). As another non-limiting example, the first type of domain representation may comprise images acquired by a given model of an imaging apparatus, and the second type of domain representation may comprise images acquired by another model of the same imaging apparatus from the same manufacturer, which may enable machine learning models to be invariant to different models of the same medical imaging apparatus.

As another non-limiting example, the unlabelled training dataset 262 may comprise drawings of objects while the labelled training dataset 232 may comprise images of the objects acquired by an imaging apparatus.

### Communication Network

In one or more embodiments of the present technology, the communications network 270 is implemented as the Internet. In one or more alternative non-limiting embodiments, the communication network 270 may be implemented as any suitable local area network (LAN), wide area network (WAN), a private communication network, a virtual communication network or the like. It will be appreciated that implementations for the communication network 270 are for illustration purposes only. How a communication link 275 (not separately numbered) between the first server 210, the first database 230, the second server 240, and the second database 250 and/or another electronic device (not shown) and the communications network 270 is implemented will depend inter alia on how each electronic device is implemented.

The communication network 270 may be used in order to transmit data packets amongst the first server 210, the first database 230, the second server 240, and the second database 250. For example, the communication network 270 may be used to transmit requests between the first server 210 and the second server 240.

In one or more embodiments of the present technology, the system 200 may be implemented as a federated learning system, where the second server 240 does not have access to the labelled training dataset 232 and the first server 210 does not have access to the unlabelled training dataset 262 (i.e., the training datasets are locally held on respective servers without exchange of training data).

It will be appreciated that the functionality of the system 200 as described herein may be implemented by a single electronic device, such as the electronic device 100.

### Hypothesis Disparity Regularized Mutual Information Maximization (HDMI) Training Procedure

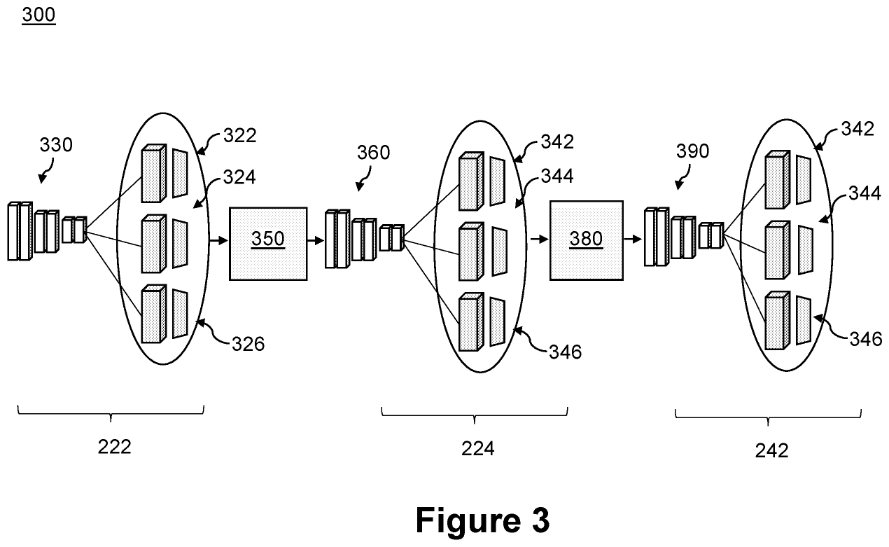

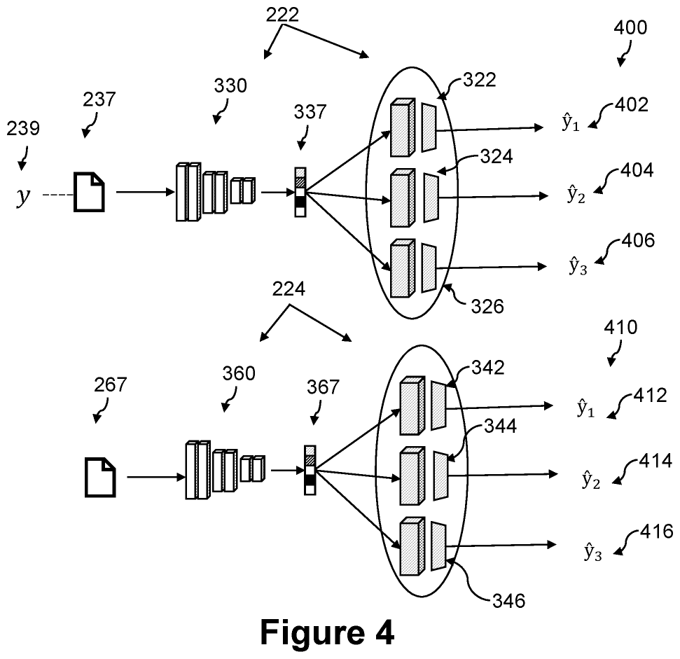

With reference to FIG. 3 and FIG. 4, there is shown a schematic diagram of a hypothesis disparity regularized mutual information maximization (HDMI) training procedure 300, the HDMI training procedure 300 being depicted in accordance with one or more non-limiting embodiments of the present technology.

In one or more embodiments of the present technology, the HDMI training procedure 300 is executed within the system 200. In one or more other embodiments, the HDMI training procedure 300 may be executed by a single processing device operatively connected to a storage medium, such as the electronic device 100.

The HDMI training procedure 300 comprises inter alia a supervised learning procedure 350 and an unsupervised learning procedure 380. The unsupervised learning procedure 380 is executed after the supervised learning procedure 350.

In one or more embodiments, a model initialization procedure may be performed prior to executing the supervised learning procedure 350.

In one or more embodiments, the first server 210 executes the model initialization procedure.

### Model Initialization Procedure

The model initialization procedure is configured to inter alia initialize model parameters and hyperparameters to obtain a set of initial ML models 222 to train. The purpose of the model initialization procedure is to define a ML model architecture and determine how the ML model will be trained according to the type of prediction task, the type of input, the type of training dataset, the training environment, and the like.

Each initial ML model of the set of initial ML models 222 has an initial common feature extractor 330, and a respective initial prediction network 322, 324, 326.

In one or more embodiments, the model initialization procedure initializes the model parameters of the initial common feature extractor 330 and the model parameters of the respective initial prediction network 322, 324, 326.

The initial common feature extractor 330 is configured to inter alia: (i) obtain a data instance; and (ii) generate a set of features therefrom, which will be used by the respective prediction network 322, 324, 326 to perform a respective prediction. It will be appreciated that generation of features from data instances by the common feature extractor 330 may be also referred to as feature extraction.

It will be appreciated that the set of features 337 may be represented as a feature vector 337. As a non-limiting example, the set of features may be a feature vector of 1024 or 2048 dimensions.

In one or more embodiments, at least a portion of the initial common feature extractor 330 may comprise a feature extractor having been previously trained to extract features. As a non-limiting example, the initial common feature extractor 330 may be implemented as a ResNet model. The ResNet model may have been pretrained on the ImageNet dataset. In such embodiments, the model parameters of previously trained portions of a common feature extractor may be obtained during the model initialization procedure, and the initial common feature extractor 330 may thus be initialized.

As a non-limiting example, the initial common feature extractor 330 may be based on one of ResNet and VGGnet.

It will be appreciated that the previously trained feature extractor may be further modified by the model initialization procedure to obtain the initial common feature extractor 330. As a non-limiting example, for ResNet, a fully connected (FC) layer with BN, ReLu and Dropout may be added to obtain the common feature extractor.

The respective initial prediction network 322, 324, 326 is configured to inter alia: (i) receive a set of features; and (ii) perform, using the set of features, a respective prediction.

Each respective initial prediction network 322, 324, 326 may process the same set of extracted features differently to perform a respective prediction due to a difference in their respective model configuration (e.g. weights or architecture in a NN). As a non-limiting example, each respective initial prediction network 322, 324, 326 may comprise two FC layers with ReLu and Dropout.

The model initialization procedure uses a different condition to initialize each respective initial prediction network 322, 324, 326 in the set of initial ML models 222.

It will be appreciated that the number of model parameters to initialize will depend on inter alia the prediction task type (classification or regression), the prediction network architecture, the set of features provided by the initial common feature extractor 330, etc.

The model initialization procedure outputs the set of initial ML models 222.

### Supervised Learning Procedure

The supervised learning procedure 350 is configured to inter alia: (i) obtain the set of initial ML models 222; (ii) obtain the labelled training dataset 232; and (iii) train the set of initial ML models 222 on the labelled training dataset 232 to obtain a first set of trained ML models 224.

In one or more embodiments, the supervised learning procedure 350 is executed by the first server 210.

In one or more other embodiments, the supervised learning procedure 350 may be executed by the second server 240. In one or more alternative embodiments, the supervised learning procedure 350 may be executed by any processing device having access to the set of initial ML models 222 and to the labelled training dataset 232.

The supervised learning procedure 350 obtains the set of initial ML models 222.

The supervised learning procedure 350 obtains the labelled training dataset 232. In one or more embodiments, the supervised learning procedure 350 obtains the labelled training dataset 232 from the first database 230. In one or more alternative embodiments, the supervised learning procedure 350 may obtain the labelled training dataset 232 from one or more other electronic devices such as the second server 240.

The supervised learning procedure 350 trains the set of initial ML models 222 based on training hyperparameters. The hyperparameters may be obtained from the model initialization procedure, may have been previously defined by an operator, may be obtained from a storage medium, or may be determined using various techniques known in the art.

It will be appreciated that one or more of the set of initial ML models 222 may be trained in sequence or in parallel. As a non-limiting example, the set of initial ML models 222 may be trained using hyperparameters comprising a learning rate of 3e-4, and a batch size of 32 for 5 k iterations.

The supervised learning procedure 350 aims to minimize an objective function. In one or more embodiments, the objective function to minimize during the supervised learning procedure 350 to obtain the first set of trained ML models 224 is expressed by equation (1):

[symbol]

_{source}= [symbol] [ [symbol] _{CE}(h(x),y)], (1)

Where X, Y, H are respectively the input space, the output space, and the hypothesis or prediction network space, x is the input, h(x)=p(y|x; h) is the output label probability distribution predicted by a given initial model h, where y∈{1 . . . K} and K is the number of classes, and l_{ce} is a cross-entropy loss function.

As best seen in FIG. 4, during the supervised learning procedure 350, the set of initial ML models 222 generates, using the initial common feature extractor 330, for a given labelled training example 237 of the labelled training dataset 232, a respective set of features in the form of a feature vector 337. The set of initial ML models 222 may generate a set of feature vectors for at least a portion (i.e., one or more) labelled examples in the labelled training dataset 232. It will be appreciated that by using the initial common feature extractor 330, the respective feature vector 337 generated for a given labelled training example 237 is shared by the set of initial ML models 222.

Each ML model of the set of initial ML models 222 uses its respective initial prediction network 322, 324, 326 to generate, for the feature vector 337 of the given labelled example 237, a respective prediction 402, 404, 406. The set of initial ML models 222 thus outputs a set of predictions 400, where each initial ML model has a respective prediction 402, 404, 406 for the given labelled example 237. It will be appreciated that one or more of the respective predictions 402, 404, 406 may be similar or may be different depending on the initial configuration parameters of each respective initial prediction network 322, 324, 326 of the set of initial ML models 222.

Each respective prediction 402, 404, 406 of the set of predictions 400 is compared to the label 239 of the given labelled example 237 and a respective loss is determined. The respective loss is determined by using a loss function. It will be appreciated that the choice of loss function depends on the type of prediction task. In one or more embodiments, for classification tasks, a cross entropy loss function may be used. In one or more other embodiments, for regression tasks, a mean squared error (MSE) loss function may be used. It will be appreciated that other types of loss functions known in the art may be used.

One or more of the set of initial ML models 222 is updated based on the respective loss calculated using an objective function. It will be appreciated that for a given iteration, some of the initial ML models may be updated while others may not necessarily be updated depending on their respective predictions for the given iteration.

The supervised learning procedure 350 is repeated on the labelled training dataset 232 until convergence to obtain a first set of trained ML models 224. As a non-limiting example, the supervised learning procedure 350 may stop upon reaching one or more of: a desired performance threshold (e.g. accuracy for classification tasks), a computing budget, a maximum training duration, a lack of improvement in performance, a system failure, and the like.

The supervised learning procedure 350 outputs the first set of trained ML models 224, where each trained ML model comprises a trained common feature extractor 360 and a respective trained prediction network 342, 344, 346.

### Unsupervised Learning Procedure

The unsupervised learning procedure 380 is configured to inter alia: (i) obtain the first set of trained ML models 224; (ii) obtain the unlabelled training dataset 262; (iii) train, by updating the trained common feature extractor 360, the first set of trained ML models 224 on the unlabelled training dataset 262 by using mutual information (MI) maximization and hypothesis disparity (HD) regularization to obtain a second set of trained ML models 242.

The unsupervised learning procedure 380 is executed by the second server 240. In one or more other embodiments, the unsupervised learning procedure 380 may be executed by the first server 210. In one or more alternative embodiments, the unsupervised learning procedure 380 may be executed by any processing device having access to the first set of trained ML models 224 and the unlabelled training dataset 262.

The unsupervised learning procedure 380 may be executed by the same processing device having performed the supervised learning procedure 350, or by a different processing device. As a non-limiting example, the unsupervised learning procedure 380 may be performed individually by one or more processing devices to adapt the first set of trained ML models 224 to their respective local datasets.

The unsupervised learning procedure 380 obtains the first set of trained ML models 224 having been trained during the supervised learning procedure 350.

The unsupervised learning procedure 380 obtains the unlabelled training dataset 262. The unsupervised learning procedure 380 obtains the first set of trained ML models 224. It will be appreciated that the first set of trained ML models may be received from the first database 230, from the first server 210 or from a storage medium of the second server 240.

The unsupervised learning procedure 380 trains the first set of trained models 224 based on unsupervised learning hyperparameters. The unsupervised learning hyperparameters may be obtained from the model initialization procedure, may have been previously defined by an operator, may be obtained from a storage medium, or may be determined using various techniques known in the art.

As a non-limiting example, the first set of trained ML models 224 may be trained during the unsupervised learning procedure 380 using a batch size of 64, a learning rate between 1 e-4 and 1 e-3 and for 20 k to 40 k iterations. The regularization weight hyperparameter A may be set to 0.5 and a number of trained models in the first set of trained ML models 224 may be 2.

As best seen in FIG. 4, during the unsupervised learning procedure 380, the first set of trained ML models 224 generates, using the trained common feature extractor 360, for a given unlabelled example 267 of the unlabelled dataset 262, a respective feature vector 367. The first set of trained ML models 224 may generate a set of feature vectors for at least a portion (i.e. one or more) unlabelled examples in the unlabelled training dataset 262.

Each trained ML model of the first set of trained ML models 224 uses its respective trained prediction network 342, 344, 346 to generate, for the respective feature vector 367 of the given unlabelled example 267 of the unlabelled dataset 262, a respective prediction 412, 414, 416. The first set of trained ML models 224 thus outputs a set of predictions 410, where each ML model has a respective prediction 412, 414, 416 for the given unlabelled example 267. It will be appreciated that one or more of the respective predictions 412, 414, 416 may be similar or may be different depending on the configuration parameters of each of the respective trained prediction network 342, 344, 346 following the supervised learning procedure 350.

The unsupervised learning procedure 380 aims to maximize mutual information and minimize hypothesis disparity during training of the first set of trained ML models 224 on the unlabelled training dataset 262.

For a given iteration, the unsupervised learning procedure 380 maximizes, for each given trained model of the first set of trained ML models 224, a mutual information between the respective feature vector 367 and the set of predictions 410 generated by the first set of trained ML models 224.

The mutual information is maximized to adapt, by updating the trained common feature extractor 360, the first set of trained ML models 224 to the unlabelled training dataset 262 to obtain the second set of trained ML models 242.

In one or more embodiments, mutual information maximization is expressed by equation (3):

$${max}_{{ψ}^{T}} {𝔼}_{h ∈ {ℋ}^{T}} [ I ( {X}^{T} ; h ( {X}^{T} ) ) ] , \qquad ( 3 )$$

Where X^{T} is the target input, h(X^{T}) is the output of a given model of the first set of trained ML models and ψ^{T} is the parameters of the trained common feature extractor 360 of the first set of trained ML models 224.

The unsupervised learning procedure 380 minimizes hypothesis disparity, which is indicative of a level of dissimilarity across the predictions of the first set of trained ML models 224 during unsupervised training, i.e. it is a dissimilarity measure between at least a given prediction of the set of predictions and at least one other given prediction of the set of predictions of the first set of trained ML models 224 for a given unlabelled training example.

In one or more embodiments, hypothesis disparity minimization is expressed by equation (4):

H [symbol] (hᵢ,hⱼ)=∫ₓd(hᵢ(x),hⱼ(x))p(x)dx,

where d(·) can be any divergence measure between the predicted label probability distributions from trained ML models.

In one or more embodiments, the unsupervised learning procedure 380 maximizes mutual information and minimize hypothesis disparity by using an objective function expressed by equation (5):

[symbol]

[−I(X^{T};h(X^{T}))]+λ [symbol] [HD(hᵢ,hⱼ)]

In one or more embodiments, to improve computational efficiency, the unsupervised learning procedure 380 may choose an “anchor” trained ML model randomly to compute an average of the disparity between the prediction of the anchor trained ML model and the other trained ML models of the first set of trained ML models 224.

In one or more embodiments, the expectation of label predictions of the second set of trained ML models 242 may be simplified to the prediction from any trained ML models that is sampled from the target posterior, which is expressed by equation (6):

p(Yₜ* [symbol] ₜ, [symbol] ₛ)≃p(Yₜ*| [symbol] ₜ,hₜ)hₜ˜p(hₜ| [symbol] ₜ,{hᵢ^{S}}ᵢ₌₁^{M}).

The unsupervised learning procedure 380 updates the trained common feature extractor 360 of each trained ML model of the first set of trained ML models 224 based on the mutual information maximization and the hypothesis disparity minimization.

In one or more embodiments, the unsupervised learning procedure 380 is repeated on the unlabelled training dataset 262 until a termination condition is reached or satisfied. As a non-limiting example, the unsupervised learning procedure 380 may stop upon reaching one or more of: a desired performance threshold (e.g. accuracy for classification tasks), a computing budget, a maximum training duration, a lack of improvement in performance, a system failure, and the like.

In one or more embodiments, the unsupervised learning procedure 380 outputs the updated common feature extractor 390. The updated common feature extractor 390 may be used subsequently to generate generalizable features which may be used as inputs by other prediction networks (e.g. different from the prediction networks 342, 344, 346) to perform predictions. The updated common feature extractor 390 may be used to extract features from data in the design and development of a radiomics signature.

The unsupervised learning procedure 380 outputs the second set of trained ML models 242, which comprises the updated common feature extractor 390 and the respective trained prediction network 342, 344, 346. Thus, it will be appreciated that during the unsupervised learning procedure 380, only the trained common feature extractor 360 has been updated to obtain the updated common feature extractor 390.

In one or more embodiments, the unsupervised learning procedure 380 outputs, based on the second set of trained ML models 242, a final trained model (not shown).

In one or more embodiments, the final trained model may be output by selecting one of the second set of trained ML models 242, i.e. the updated common feature extractor 390 and one of the respective prediction networks 342, 344, 346. In one or more other embodiments, the final trained model may comprise the second set of trained ML models 242 as a single ensemble model. It will be appreciated that other approaches may be used to output the final trained model comprising the updated common feature extractor 390.

It will be appreciated that employment of multiple machine learning models is relevant to domain adaptation with out-of-distribution examples and has an impact on the uncertainty calibration and adaptation/transfer performance, thus enabling to obtain models that are robust to domain shift.

The HDMI training procedure 300 enables aligning the first set of trained ML models 224 in a way such that the uncertainty manifested through different ML models after the supervised learning procedure 350 is taken into account while the undesirable disagreements are marginalized out during the unsupervised learning procedure 380 by updating the trained common feature extractor 360 to obtain the updated common feature extractor 390.

The HDMI training procedure 300 enables optimizing the second set of trained ML models 242 by utilizing the relationship among multiple ML models to overcome the limitation of mutual information maximization with a single trained ML model.

It will be appreciated that the HDMI training procedure 300 may be used in the context of continual learning and decentralized federated learning to enable parties to collaborate and contribute to the improvement of a feature extractor, while also specializing the feature extractor on local datasets (which are private and not shared between participating devices in the context of federated learning). Thus, the HDMI training procedure 300 including the supervised learning procedure 350 and/or the unsupervised learning procedure 380 may be repeated a plurality of times across different processing devices on local training datasets. In one or more alternative embodiments, the second server 240 may comprise or be replaced by a first client device and a second client device, and during the unsupervised learning procedure 380, the first client device may only have access to a first subset of the first set of trained ML models 224 for training thereof and the second client device may only have access to a second subset of the first set of trained ML models 224 for training thereof, where a size of each of the first subset and the second subset of the first set of trained ML models 224 and their overlap (i.e. the intersection of the first subset and the second subset) may be may be determined based on a criteria such as the nature of the relation between the client devices, and/or a pre-established business model.

In one or more other embodiments, client or processing devices participating to the HDMI training procedure 300 may be decentralized (i.e. peer-to-peer), and each client device may perform the supervised learning procedure 350 and/or the unsupervised learning procedure 380 on a respective local training dataset for the common prediction task, adding new relevant data to the respective local training dataset to improve the performance of the updated common feature extractor. Each client device may share, to other decentralized client devices, the local version of the updated common feature extractor and optionally the trained prediction networks resulting from training on the respective local training dataset, without sharing any local training data between the client devices. Each client device may then perform locally the further training of the updated common feature extractor, and optionally the trained prediction network, to thereby obtain a further local updated version of the updated common feature extractor. Such a process enables the client device(s) to benefit from training performed by other client devices, without sharing local data or accessing training data of the other client devices, while also specializing the updated common feature extractor locally, which benefits entities associated with the client device(s) while minimizing data privacy concerns.

The HDMI training procedure 300 may be used to identify a feature extractor architecture and/or type that is invariant to different types of domains, which may be used in fields such as, but not limited to, radiomics. The HDMI training procedure 300 may also be used in the context of continual learning to adapt a pre-trained model to a particular dataset (e.g., adapt a ML model to a dataset associated with a given hospital using a pre-trained model having been trained on a dataset associated with another hospital).

In one or more alternative embodiments, at least the updated feature extractor 390 obtained using the HDMI training procedure 300 may be used as part of a feature extractor for a prediction task other than the common prediction task for which it was trained during the HDMI training procedure 300. Thus, due to the generalized feature extracting capabilities and/or adaptation to domain shifting learned during the HDMI training procedure 300, the updated feature extractor 390 may be used in combination with further prediction networks and may be retrained for other prediction tasks, without using mutual information maximization and hypothesis disparity minimization. Such embodiments are particularly useful in the context of multiple parties accepting to work collaboratively on improving the quality of a common feature extractor, while retaining the benefits of not disclosing the particular local task(s) of interest of each of the parties.

### Method Description

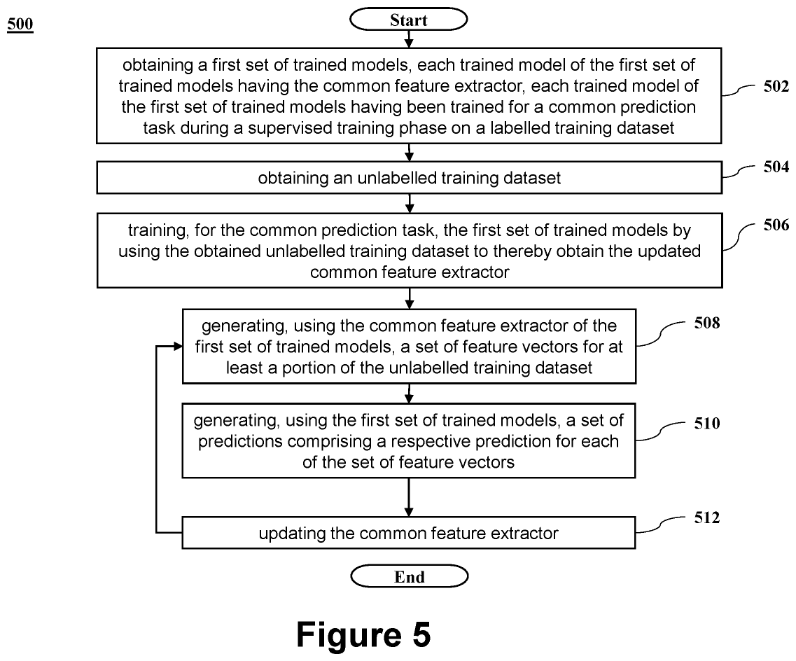

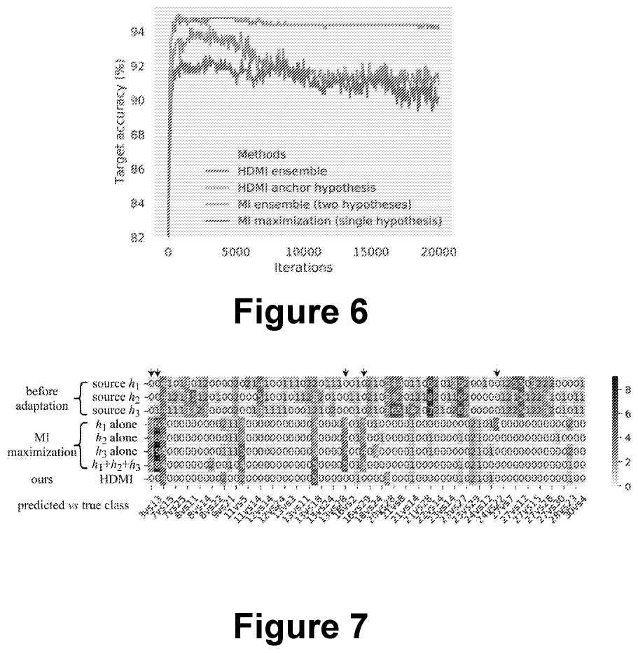

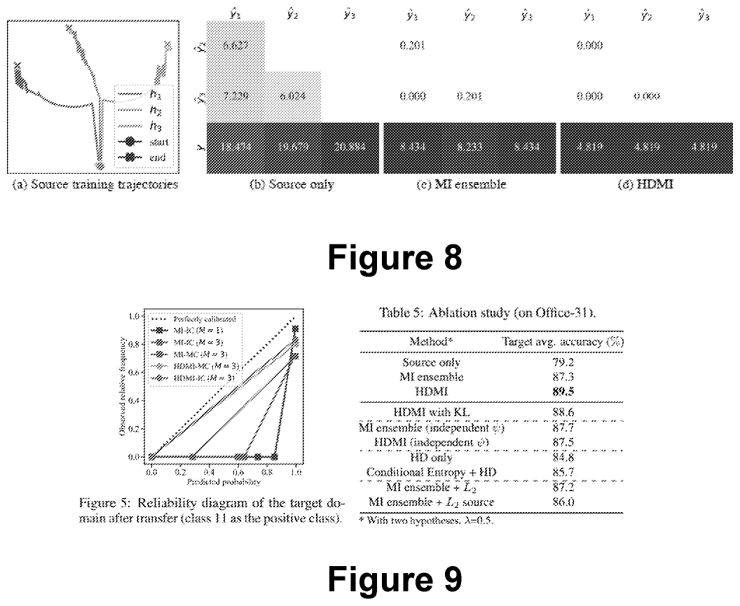

FIG. 5 depicts a flowchart of a method 500 of training a first set of trained models each comprising a common feature extractor by using an unlabelled training dataset to thereby obtain an updated common feature extractor, the method 500 being depicted in accordance with one or more non-limiting embodiments of the present technology. The method 500 may be executed by the second server 240.

In one or more embodiments, the second server 240 comprises a processing device such as the processor 110 and/or the GPU 111 operatively connected to a non-transitory computer readable storage medium such as the solid-state drive 120 and/or the random-access memory 130 storing computer-readable instructions. The processing device, upon executing the computer-readable instructions, is configured to or operable to execute the method 500.

At processing step 502, the processing device obtains the first set of trained ML models 224. In one or more embodiments, the processing device obtains the first set of trained ML models from the first database 230 or the non-transitory computer readable storage medium.

In one or more alternative embodiments, the processing device obtains the first set of trained ML models 224 from the first server 210. In one or more other embodiments, the processing device may obtain the first set of trained ML models 224 from another electronic device connected to the communications network 270.

At processing step 504, the processing device obtains the unlabelled training dataset 262. In one or more embodiments, the processing device obtains the unlabelled training dataset 262 from the second database 250.

At processing step 506, the processing device trains the first set of trained ML models 224 by using the obtained unlabelled training dataset 262 to thereby obtain the updated common feature extractor 390. In one or more embodiments, processing step 506 comprises training processing steps 508, 510 and 512, which are repeated iteratively.

According to processing step 508 the processing device generates, using the trained common feature extractor 360 of the first set of trained ML models 224, a set of feature vectors for at least a portion of the unlabelled training dataset 262.

According to processing step 510, the processing device uses the first set of trained ML models 224 to generate a set of predictions 410. Each trained ML model of the first set of trained ML models 224 generates, for the feature vector 367 of the given unlabelled example 267 of the unlabelled training dataset 262, a respective prediction 412, 414, 416. The first set of trained ML models 224 thus outputs a set of predictions 410, where each trained ML model has a respective prediction 412, 414, 416 for the feature vector 367 output by its respective trained prediction network 342, 344, 346.

According to processing step 512, the processing device maximizes, for each given trained model of the first set of trained ML models 224, a mutual information between the set of feature vectors and the respective predictions generated by the first set of trained ML models 224.

In one or more embodiments, the processing device minimizes a dissimilarity measure between at least a given prediction of the set of predictions and at least one other given prediction of the set of predictions of the first set of trained ML models 224 for the given unlabelled training example 267. In one or more embodiments, the processing device minimizes the dissimilarity measure during processing step 512,

Processing steps 508 to 512 may be repeated until a termination condition is reached.

The method 500 then ends.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

### Experiments

### Setup

Implementations of the present technology have been validated on three benchmark datasets for UDA in the context of HTL, and its adaptation/transfer performance has been compared with various state-of-the-art UDA and HTL methods as baselines. In the following, the validated implementations of the present technology are referred to as hypothesis disparity regularized mutual information maximization (HDMI).

### Datasets

Office-31 has three domains: Amazon (A), DSLR (D) and Webcam (W), which contains 31 classes and 4,652 images. Office-Home is a more challenging dataset that consists of 65 classes and 15,500 images in four domains: Artistic images (Ar), Clip art (CI), Product images (Pr) and Real-World images (Rw). VisDA-C is a large-scale dataset with 12 classes, where the source domain has 152,397 Synthetic images and the target domain contains 55,388 Real images.

### Baselines

The baseline methods can be divided into two categories depending on whether the model has access to both source and target domain data during adaptation. Most of the previous unsupervised domain adaptation methods (e.g., DAN [23], DANN [7], rRevGrad+CAT [48], CDAN+BSP [49], CDAN+TransNorm [50], SAFN+ENT [51], MDD [27]) require source data access during adaptation, whereas SHOT-IM [9] and SHOT [9] are unsupervised HTL methods without the source data access constraint. Source was only reported, which directly applies the source hypothesis to obtain the target predictions without any adaptation, and MI ensemble, which uses multiple hypotheses for MI maximization but without the HD regularization. In addition, the results of two other regularization approaches, namely MI ensemble+L2 and MI ensemble+L2 source were also reported. The HDMI with independent classifiers (IC) from different random initialization is referred to as HDMI-IC, so as to be distinguished from the MC-dropout based multiple-classifier approach denoted as HDMI-MC.

### Results

State-of-the-art performance of HDMI Results for Office-31 are presented in Table 1, Office-Home are presented in Table 2, and VisDA-C are presented in Table 3. The per-class accuracy for VisDA-C is detailed in Table 6. As seen from all tables, the proposed HDMI achieves state-of-the-art performance on the target domains in all datasets, even outperforming the methods that have additional access to the source data during adaptation (methods for which “source” marked as ✓in the tables). In unsupervised HTL setting (methods for which “source” marked as X in the tables), HDMI also outperforms previous state-of-the-art methods SHOT-IM (also based on MI maximization) and SHOT (with an extra pseudo-label based self-training strategy) [9]. Compared with MI ensemble, adding the HD regularization effectively increases the target accuracy from 87.3% to 89.5% on Office-31, from 69.2% to 71.9% on Office-Home, and from 72.4% to 82.4% on VisDA-C. In addition, the proposed HD regularization in HDMI was found to be superior to other forms of regularization such as those presented in MI ensemble+L2 and MI ensemble+L2 source, as shown in Table 1.

TABLE 1
Target accuracy (%) on Office-31 with ResNet-50.

| Source | # of Hypotheses | Method | A→D | A→W | D→A | D→W | W→A | W→D | Avg. |
|---|---|---|---|---|---|---|---|---|---|
| ✓ | single | DAN [23] | 78.6 | 80.5 | 63.6 | 97.1 | 62.8 | 99.6 | 80.4 |
| | | DANN [7] | 79.7 | 82.0 | 68.2 | 96.9 | 67.4 | 99.1 | 82.2 |
| | | SAFN + ENT [51] | 90.7 | 90.1 | 73.0 | 98.6 | 70.2 | 99.8 | 87.1 |
| | | rRevGrad + CAT [48] | 90.8 | 94.4 | 72.2 | 98.0 | 70.2 | 100. | 87.6 |
| | | CDAN + BSP [49] | 93.0 | 93.3 | 73.6 | 98.2 | 72.6 | 100. | 88.5 |
| | | MDD [27] | 93.5 | 94.5 | 74.6 | 98.4 | 72.2 | 100. | 88.9 |
| X | single | Source only | 79.7 | 75.7 | 61.2 | 96.0 | 59.8 | 98.2 | 78.4 |
| | | MI maximization | 90.2 | 92.3 | 73.0 | 96.5 | 73.1 | 95.0 | 86.7 |
| | | SHOT [9] | 93.1 | 90.9 | 74.5 | 98.8 | 74.8 | 99.9 | 88.7 |
| | multiple* | Source only | 81.1 | 77.2 | 61.2 | 96.5 | 60.7 | 98.4 | 79.2 |
| | | MI ensemble | 91.0 | 93.0 | 72.3 | 96.5 | 73.7 | 97.4 | 87.3 |
| | | MI ensemble + L₂ | 93.6 | 93.2 | 70.4 | 96.0 | 72.5 | 97.6 | 87.2 |
| | | MI ensemble + L₂ source | 92.0 | 91.7 | 68.7 | 97.9 | 66.1 | 99.8 | 86.0 |
| | | HDMI (λ = 0.5) | 94.4 | 94.0 | 73.7 | 98.9 | 75.9 | 99.8 | 89.5 |
| | | HDMI ensemble (λ = 0.5) | 94.4 | 94.0 | 73.6 | 98.9 | 75.9 | 99.8 | 89.4 |

*Two hypotheses as a illustration. More examples are shown in Table 4.

TABLE 2
Target accuracy (%) on Office-Home with ResNet-50.

| Method | Ar→Cl | Ar→Pr | Ar→Rw | Cl→Ae | Cl→Pr | Cl→Rw | Pr→Ar | Pr→Cl | Pr→Rw | Rw→Ar | Rw→Cl | Rw→Pr | Avg. |
|---|---|---|---|---|---|---|---|---|---|---|---|---|---|
| DAN [23] | 43.6 | 57.0 | 67.9 | 45.8 | 56.5 | 60.4 | 44.0 | 43.6 | 67.7 | 63.1 | 51.5 | 74.3 | 56.3 |
| DANN [7] | 45.6 | 59.3 | 70.1 | 47.0 | 58.5 | 60.9 | 46.1 | 43.7 | 68.5 | 63.2 | 51.8 | 76.8 | 57.6 |
| SAFN [51] | 52.0 | 71.7 | 76.3 | 64.2 | 69.9 | 71.9 | 63.7 | 51.4 | 77.1 | 70.9 | 57.1 | 81.5 | 67.3 |
| CDAN + | 50.2 | 71.4 | 77.4 | 59.3 | 72.7 | 73.1 | 61.0 | 53.1 | 79.5 | 71.9 | 59.0 | 82.9 | 67.6 |
| TransNorm [50] | | | | | | | | | | | | | |
| MDD [27] | 54.9 | 73.7 | 77.8 | 60.0 | 71.4 | 71.8 | 61.2 | 53.6 | 78.1 | 72.5 | 60.2 | 82.3 | 68.1 |
| SHOT-IM [9] | 52.8 | 72.9 | 78.4 | 65.4 | 73.8 | 74.1 | 64.6 | 50.8 | 78.9 | 72.7 | 53.5 | 81.2 | 68.3 |
| SHOT [9] | 56.9 | 78.1 | 81.0 | 67.9 | 78.4 | 78.1 | 67.0 | 54.6 | 81.8 | 73.4 | 58.1 | 84.5 | 71.6 |
| Source only* | 45.6 | 69.2 | 76.5 | 55.3 | 64.4 | 67.4 | 55.1 | 41.6 | 74.4 | 66.0 | 46.3 | 79.4 | 61.8 |
| MI ensemble* | 55.2 | 71.9 | 80.2 | 62.6 | 76.8 | 77.8 | 63.2 | 53.8 | 81.1 | 67.9 | 58.3 | 81.4 | 69.2 |
| HDMI (λ = 0.3)* | 57.4 | 76.9 | 81.6 | 67.6 | 79.1 | 78.1 | 65.1 | 56.0 | 82.5 | 73.5 | 59.5 | 83.6 | 71.7 |
| HDMI (λ = 0.4)* | 57.8 | 76.7 | 81.9 | 67.1 | 78.8 | 78.8 | 66.6 | 55.5 | 82.4 | 73.6 | 59.7 | 84.0 | 71.9 |

*Two hypotheses as an illustration.

### Robust Performance of HDMI

To validate the robustness of HDMI in terms of the number of hypotheses M used and the hyperparameter λ choices, experiments on A→D were performed on Office-31 with different combinations of M and λ values, and the target performance is summarized in Table 4. It can be shown that HDMI consistently obtains improved performance over the MI maximization baseline without the HD regularization in most cases. It is also reported that the implementation of HDMI with independent classifiers (HDMI-IC) is preferable to that with MC-dropout (HDMI-MC).

### Analyses

In-depth analyses of HDMI compared with the baselines such as Source only, single hypothesis MI maximization, and MI ensemble are provided to investigate how multiple hypotheses and HD regularization affect the MI maximization process.

TABLE 3
Target domain per-class average accuracy (%)
on VisDA-C (Synthetic→Real) with ResNet-101.

| Source | Method | Avg. per-class accuracy |
|---|---|---|
| ✓ | JAN [52] | 61.6 |
| | GTA[53] | 69.5 |
| | MCD [26] | 71.9 |
| | CDAN [54] | 70.0 |
| | MDD [27] | 74.6 |
| | SHOT-IM [9] | 77.9 |
| | SHOT [9] | 79.6 |
| X | Source only | 44.6 |
| | MI ensemble (two hypotheses) | 72.4 |
| | HDMI (two hypotheses, λ = 0.5) | 82.4 |

TABLE 4
Robustness of HDMI (Target accuracy (%) on A→D, Office-
31). HDMI is robust to the choices of the number of hypotheses
used (M) and weight hyperparameter tuning (λ).

| | | | HDMI | | | | | |
|---|---|---|---|---|---|---|---|---|
| # of | | | HDMI-IC | | | | | HDMI-MC |
| Hypotheses | Source | MI | λ = | λ = | λ = | λ = | λ = | λ = |
| (M) | only | maximization | 0.1 | 0.3 | 0.5 | 0.7 | 1.4 | 0. [symbol] |
| 2 | 81.1 | 91.9 | 92.2 | 94.2 | 94.4 | 93. [symbol] | 94. [symbol] | 9 [symbol] .6 |
| 3 | 81.5 | 91. [symbol] | 93.2 | 94.0 | 9 [symbol] .2 | 9 [symbol] .6 | 9 [symbol] .6 | 93.2 |
| 4 | 82.3 | 92.8 | 9 [symbol] .6 | 94.4 | 95.0 | 96. [symbol] | 94.6 | 91.0 |
| 5 | 82.1 | 9 [symbol] .2 | 9 [symbol] .2 | 93. [symbol] | 93.4 | 92.8 | 92.8 | 89.6 |

[symbol]

indicates data missing or illegible when filed

The HD regularization stabilizes MI maximization, and FIG. 6 shows the target accuracy curves of different approaches with or without the HD regularization. As seen in the figure, the target performance degrades in both MI ensemble and single hypothesis MI maximization with more training whereas the HD regularization stabilizes the curves of HDMI anchor hypothesis and HDMI ensemble, possibly by reducing overfitting of the hypotheses to the target data with effective regularization. HDMI preserves more transferable source knowledge. The prediction errors made by different approaches were further investigated and their error patterns were analyzed. As summarized in FIG. 7, the adaptation of source hypotheses to the target data via MI maximization (row 4-7) introduces new errors that were not present in the Source only models (row 1-3), e.g., columns with arrows, indicating partial lost of the transferable source knowledge during target adaptation. However, HDMI (row 8) preserved more transferable source knowledge, e.g., columns with arrows, which is beneficial to the transfer performance since it covers diverse modes for the target domain (FIG. 8 (a)).

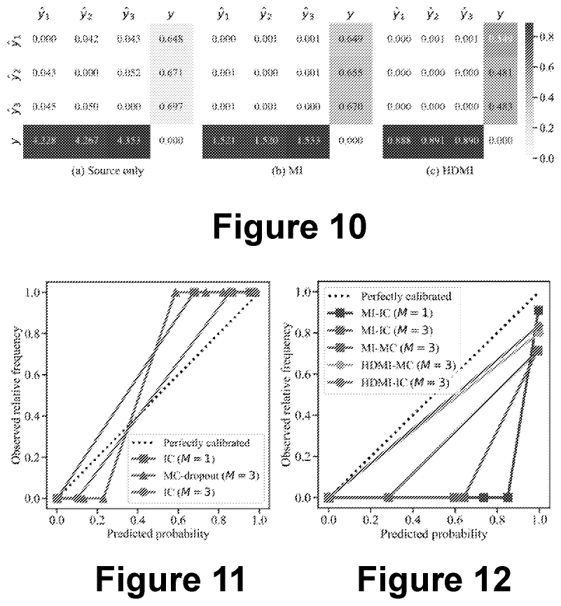

HDMI maximally reduces the disagreement among target hypotheses FIG. 8 (b)-(d) compare the disagreement among predictions from different target hypotheses and the ground-truth labels, where HDMI (FIG. 8 (d)) is shown to maximally reduce the disagreement compared with Source only (FIG. 8 (b)) and MI ensemble (FIG. 8 (c)), demonstrating the effectiveness of the HD regularization in bringing target hypotheses to align with each other. Consistent with the disagreement analysis, similar findings were obtained when analyzing the KL divergence of example-level predictions between target hypotheses (FIG. 10).

TABLE 5
Ablation study (on Office-31).

| Method* | Target avg. accuracy (%) |
|---|---|
| Source only | 79.2 |
| MI ensemble | 87.3 |
| HDMI | 89.5 |
| HDMI with KL | 88.6 |
| MI ensemble (independent ϕ) | 87.7 |
| HDMI (independent ϕ) | 87.5 |
| HD only | 84.8 |
| Conditional Entropy + HD | 85.7 |
| MI ensemble + L₂ | 87.2 |
| MI ensemble + L₂ source | 86.0 |

*With two hypotheses, λ = 0.5.

HDMI presents well-calibrated predictive uncertainty, and the reliability diagram [55, 56] of different approaches was plotted and it was shown that HDMI is better calibrated than other approaches (FIG. 9). Consistent with [20], multiple hypotheses using independent classifiers (IC) were found to be superior to that with MC-dropout sampled classifiers (MC) in both cases of MI ensemble and HDMI. Quantitative analysis of the uncertainty calibration confirmed that HDMI has the best Brier score and the expected calibration error (ECE) score (Table 7, supplementary material).

### Ablation Study

Various ablation studies have been performed and the comparisons summarized in Table 5. Compared with the proposed implementation of using shared feature extractor ψ among target hypotheses, HD regularization fails to improve over MI ensemble if using independent feature extractors, suggesting that HD regularization works through learning better representations shared by different target hypotheses. In addition, MI maximization was found to perform better than conditional entropy minimization in unsupervised HTL, similar to the finding in discriminative clustering [2]. Lastly, the cross-entropy measure is shown to surrogate the proposed hypothesis disparity better than KL divergence.

### Supplementary Material

### Implementation Details

Similar to previous work [27, 9], ResNet models (e.g., ResNet-50 for office datasets and ResNet-101 for the VisDA-C dataset) pretrained on ImageNet have been adopted as the backbone inside the feature extractor ψ. The ResNet backbone was then followed by a bottleneck layer (a FC layer with BN, ReLU and Dropout). The extracted feature dimension was 1024 for Office-31, and 2048 for both Office-Home and VisDA-C. The same architecture choices were followed as in for the classifiers {fᵢ}ᵢ₌₁^{M}, i.e., two-layer neural networks (two FC layers with ReLU and Dropout).

To train the source hypotheses, a learning rate 3e-4 with batch size 32 for 5 k iterations was used. The target hypotheses were trained with a larger batch size 64, learning rate 3e-4 (Office-31), 1 e-3 (Office-Home) and 1e-4 (VisDA-C) for 20 k iterations (40 k for VisDA-C). The hyperparameter λ was set to 0.5 and the number of hypotheses M was set to 2 by default. The SGD optimizer was used with nesterov momentum 0.9 and weight decay 5e-4 for training both source and target hypotheses. Following [27, 9], the ResNet backbone in the feature extractor ψ was fine-tuned with a 10 times smaller learning rate.

### Additional Results

Detailed per-class accuracy on VisDA-C

TABLE 6
Target accuracy (%) on VisDA-C (Synthetic→Real) with ResNet-101.

| Method | aeroplane | bicycle | bus | car | horse | knife | motorcycle | person | plant | skateboard | train | truck | Per-class |
|---|---|---|---|---|---|---|---|---|---|---|---|---|---|
| ResNet-101 [58] | 55.1 | 53.3 | 61.9 | 59.1 | 80.6 | 17.9 | 79.7 | 31.2 | 81.0 | 26.5 | 73.5 | 8.5 | 52.4 |
| DANN [7] | 81.9 | 77.7 | 82.8 | 44.3 | 83.2 | 29.5 | 65.1 | 28.6 | 51.9 | 54.6 | 82.8 | 7.8 | 57.4 |
| DAN [23] | 87.1 | 63.0 | 76.5 | 42.0 | 90.3 | 42.9 | 85.9 | 53.1 | 49.7 | 36.3 | 85.8 | 20.7 | 61.1 |
| ADR [60] | 94.2 | 48.5 | 84.0 | 72.9 | 90.1 | 74.2 | 92.6 | 72.5 | 80.8 | 61.8 | 82.2 | 28.8 | 73.5 |
| CDAN [54] | 85.2 | 66.9 | 83.0 | 50.8 | 84.2 | 74.9 | 88.1 | 74.5 | 83.4 | 76.0 | 81.9 | 38.0 | 73.9 |
| CDAN + BSP [49] | 92.4 | 61.0 | 81.0 | 57.5 | 89.0 | 80.6 | 90.1 | 77.0 | 84.2 | 77.9 | 82.1 | 38.4 | 75.9 |
| SAFN [51] | 93.6 | 61.3 | 84.1 | 70.6 | 94.1 | 79.0 | 91.8 | 79.6 | 89.9 | 55.6 | 89.0 | 24.4 | 76.1 |
| SWD [61] | 90.8 | 82.5 | 81.7 | 70.5 | 91.7 | 69.5 | 86.3 | 77.5 | 87.4 | 63.6 | 85.6 | 29.2 | 76.4 |
| SHOT-IM [9] | 89.9 | 80.1 | 79.1 | 50.9 | 88.0 | 90.5 | 78.2 | 78.5 | 89.3 | 80.2 | 85.8 | 44.9 | 77.9 |
| SHOT [9] | 92.6 | 81.1 | 80.1 | 58.5 | 89.7 | 86.1 | 81.5 | 77.8 | 89.5 | 84.9 | 84.3 | 49.3 | 79.6 |
| Source only* | 58.3 | 12.1 | 45.2 | 60.9 | 64.7 | 9.1 | 88.5 | 12.1 | 62.0 | 30.9 | 86.7 | 4.7 | 44.6 |
| MI ensemble* | 95.3 | 84.3 | 76.2 | 47.5 | 91.0 | 22.5 | 73.6 | 75.6 | 82.0 | 76.2 | 87.6 | 56.7 | 73.4 |
| HDMI (λ = 0.5)* | 94.7 | 85.1 | 80.3 | 62.3 | 92.1 | 95.5 | 86.4 | 77.8 | 84.8 | 85.7 | 88.4 | 55.4 | 82.4 |

*With two hypotheses.

Label probability disagreement analysis based on KL divergence

Quantitative analysis on uncertainty calibration

TABLE 7
Evaluation of uncertainty calibration
on the target domain (A→D, Office-31).

| | classifiers | # hypotheses | Brier score | ECE |
|---|---|---|---|---|
| Source only | independent | 1 | 0.2898 | 0.0124 |
| | MC-dropout | 3 | 0.3171 | 0.0133 |
| | independent | 3 | 0.2763 | 0.0116 |
| MI | independent | 1 | 0.1634 | 0.0057 |
| | MC-dropout | 3 | 0.1584 | 0.0053 |
| | independent | 3 | 0.1593 | 0.0054 |
| HDMI | MC-dropout | 3 | 0.1566 | 0.0051 |
| | independent | 3 | 0.0961 | 0.0031 |

Detailed ablation study on feature extractor

TABLE 8
Comparing shared feature extractor with independent
feature extractor. Target accuracy (%) on Office-31.

| Method* | A→D | A→W | D→A | D→W | W→A | W→D | Avg. |
|---|---|---|---|---|---|---|---|
| MI ensemble (independent feature extractor) | 92.4 | 92.7 | 70.7 | 98.7 | 71.9 | 100. | 87.7 |
| MI ensemble (shared feature extractor) | 91.0 | 93.0 | 72.3 | 96.5 | 73.7 | 97.4 | 87.3 |
| HDMI (independent feature extractor) | 91.5 | 92.3 | 71.9 | 98.6 | 71.1 | 99.6 | 87.5 |
| HDMI (shared feature extractor) | 94.4 | 94.0 | 73.7 | 98.9 | 75.9 | 99.8 | 89.5 |

*with two hypotheses, and λ = 0.5 for HD.

Detailed ablation study on conditional entropy minimization

TABLE 9
Comparing MI maximization and conditional entropy minimization,
both with HD regularization. Target accuracy (%) on Office-31.

| Method | A→D | A→W | D→A | D→W | W→A | W→D | Avg. |
|---|---|---|---|---|---|---|---|
| Source only (single hypothesis) | 79.7 | 75.7 | 61.2 | 96.0 | 59.8 | 98.2 | 78.4 |
| MI maximization (single hypothesis) | 90.2 | 92.3 | 73.0 | 96.5 | 73.1 | 95.0 | 86.7 |
| Conditional Entropy minimization (single hypothesis) | | | | | | | |
| HD only* | 93.4 | 90.4 | 65.7 | 98.5 | 60.8 | 99.8 | 84.8 |
| Conditional Entropy ensemble* | 96.6 | 91.1 | 67.3 | 98.5 | 62.1 | 99.8 | 85.9 |
| Conditional Entropy + HD* | 95.0 | 90.8 | 68.8 | 98.5 | 61.2 | 99.8 | 85.7 |
| MI ensemble* | 91.0 | 93.0 | 72.3 | 96.5 | 73.7 | 97.4 | 87.3 |
| HDMI* | 94.4 | 94.0 | 73.7 | 98.9 | 75.9 | 99.8 | 89.5 |

*with two hypotheses, and λ = 0.5 for HD. Fine-tuning on HD regularized conditional entropy minimization still does not outperform HDMI (Table 10 supplementary material)

HDMI with cross entropy or Kullback—Leibler divergence for HD

Here, the relationship between two different implementations of HDMI is presented, i.e., with either cross entropy (CE) or Kullback—Leibler (KL) divergence for the HD regularization. As shown in the following equation (Eq. 9), the objective function for the target training using CE (L_{target}^{CE based}) can be viewed as that of using KL divergence (L_{target}^{KL based}) with additional emphasis on the predictive confidence of the anchor hypothesis hi, where i∈[1, M].

TABLE 10
Fine-tuning on hypothesis disparity regularized
conditional entropy minimization does not outperform
HDMI. Target accuracy (%) on A→W, Office-31.

| | |
|---|---|
| HDMI | Conditional Entropy + HD |

| λ = 0.5 | λ = 0.1 | λ = 0.3 | λ = 0.5 | λ = 0.7 | λ = 1.0 |
|---|---|---|---|---|---|
| 94.0 | 90.8 | 90.9 | 90.8 | 90.9 | 88.8 |

$$\begin{matrix}{L}_{target}^{CE based} = \text{?} - I ( {X}^{T} ; {\hat{Y}}_{m}^{T} ) + λ \text{?} \text{?} [ H ( \text{?} ( x ) , {h}_{j} ( x ) ) ] \\ = \text{?} - I ( {X}^{T} ; {\hat{Y}}_{m}^{T} ) + λ \text{?} \text{?} [ - {\sum }_{K} {h}_{i} ( x ) log {h}_{j} ( x ) ] \\ = \text{?} - I ( {X}^{T} ; {\hat{Y}}_{m}^{T} ) + λ \text{?} \text{?} [ - {\sum }_{K} {h}_{i} ( x ) log {h}_{i} ( x ) \text{?} - \\ {\sum }_{K} {h}_{i} ( x ) log ( \frac{\text{?} ( x )}{\text{?} ( x )} ) ] \\ = \text{?} ( H ( {\hat{Y}}_{m}^{T} \vert {X}^{T} ) - H ( {\hat{Y}}_{m}^{T} ) ) + λ \text{?} ( H ( {\hat{Y}}_{i}^{T} \vert {X}^{T} ) + \\ \text{?} [ {D}_{KL} ( {h}_{i} ( x ) \text{?} {h}_{j} ( x ) ) ] ) \\ = \text{?} ( H ( {\hat{Y}}_{m}^{T} \vert {X}^{T} ) - H ( \text{?} ) ) + λ ( M - 1 ) H ( {\hat{Y}}_{i}^{T} \vert {X}^{T} ) + \\ {\sum }_{j \neq i} \text{?} \text{?} {D}_{KL} ( \text{?} ( x ) \text{?} {h}_{j} ( x ) ) ] \\ = {L}_{target}^{KL based} + λ ( M - 1 ) H ( \text{?} \vert {X}^{T} )\end{matrix} \qquad ( 9 )$$

$$\text{?} \text{indicates text missing or illegible when filed}$$

TABLE 11
Comparing cross entropy and KL divergence
for HD. Target accuracy (%) on Office-31.

| Method* | A→D | A→W | D→A | D→W | W→A | W→D | Avg |
|---|---|---|---|---|---|---|---|
| HDMI with KL | 93.2 | 93.5 | 73.8 | 97.0 | 74.3 | 99.8 | 88.6 |
| HDMI with CE | 94.4 | 94.0 | 73.7 | 98.9 | 75.9 | 99.8 | 89.5 |

*with two hypotheses, and λ = 0.5 for HD.

### REFERENCES

[1] John S Bridle, Anthony J R Heading, and David J C MacKay. Unsupervised classifiers, mutual information and phantom targets. In Advances in neural information processing systems, pages 1096-1101, 1992.
[2] Andreas Krause, Pietro Perona, and Ryan G Gomes. Discriminative clustering by regularized information maximization. In Advances in neural information processing systems, pages 775-783, 2010.
[3] Weihua Hu, Takeru Miyato, Seiya Tokui, Eiichi Matsumoto, and Masashi Sugiyama. Learning discrete representations via information maximizing self-augmented training. In Proceedings of the 34th International Conference on Machine Learning-Volume 70, pages 1558-1567. JMLR. org, 2017.
[4] R Devon Hjelm, Alex Fedorov, Samuel Lavoie-Marchildon, Karan Grewal, Phil Bachman, Adam Trischler, and Yoshua Bengio. Learning deep representations by mutual information estimation and maximization. arXiv preprint arXiv:1808.06670, 2018.
[5] Yonglong Tian, Dilip Krishnan, and Phillip Isola. Contrastive multiview coding. arXiv preprint arXiv:1906.05849, 2019.
[6] Aaron van den Oord, Yazhe Li, and Oriol Vinyals. Representation learning with contrastive predictive coding. arXiv preprint arXiv:1807.03748, 2018.
[7] Yaroslav Ganin and Victor Lempitsky. Unsupervised domain adaptation by backpropagation. In Proceed-ings of the 32nd International Conference on International Conference on Machine Learning-Volume 37, pages 1180-1189, 2015.
[8] Ilja Kuzborskij and Francesco Orabona. Stability and hypothesis transfer learning. In International Conference on Machine Learning, pages 942-950, 2013.
[9] Jian Liang, Dapeng Hu, and Jiashi Feng. Do we really need to access the source data? source hypothesis transfer for unsupervised domain adaptation. arXiv preprint arXiv:2002.08546, 2020.
[10] Shai Ben-David and Ruth Urner. Domain adaptation as learning with auxiliary information. In New directions in transfer and multi-task-workshop@ NIPS, 2013.
[11] Michaël Perrot and Amaury Habrard. A theoretical analysis of metric hypothesis transfer learning. In International Conference on Machine Learning, pages 1708-1717, 2015.
[12] Ilja Kuzborskij and Francesco Orabona. Fast rates by transferring from auxiliary hypotheses. Machine Learning, 106(2):171-195, 2017.
[13] Li Fei-Fei, Rob Fergus, and Pietro Perona. One-shot learning of object categories. IEEE transactions on pattern analysis and machine intelligence, 28(4):594-611, 2006.
[14] Jun Yang, Rong Yan, and Alexander G Hauptmann. Cross-domain video concept detection using adaptive svms. In Proceedings of the 15th ACM international conference on Multimedia, pages 188-197, 2007.
[15] Francesco Orabona, Claudio Castellini, Barbara Caputo, Angelo Emanuele Fiorilla, and Giulio Sandini. Model adaptation with least-squares svm for adaptive hand prosthetics. In 2009 IEEE International Conference on Robotics and Automation, pages 2897-2903. IEEE, 2009.
[16] Luo Jie, Tatiana Tommasi, and Barbara Caputo. Multiclass transfer learning from unconstrained priors. In 2011 International Conference on Computer Vision, pages 1863-1870. IEEE, 2011.
[17] Tatiana Tommasi, Francesco Orabona, and Barbara Caputo. Learning categories from few examples with multi model knowledge transfer. IEEE transactions on pattern analysis and machine intelligence, 36(5):928-941, 2013.
[18] Simon S Du, Jayanth Koushik, Aarti Singh, and Barnabas Poczos. Hypothesis transfer learning via transformation functions. In Advances in neural information processing systems, pages 574-584, 2017.
[19] Kelwin Fernandes and Jaime S Cardoso. Hypothesis transfer learning based on structural model similarity. Neural Computing and Applications, 31(8):3417-3430, 2019.
[20] Balaji Lakshminarayanan, Alexander Pritzel, and Charles Blundell. Simple and scalable predictive uncertainty estimation using deep ensembles. In Advances in neural information processing systems, pages 6402-6413, 2017.
[21] Sinno Jialin Pan and Qiang Yang. A survey on transfer learning. IEEE Transactions on knowledge and data engineering, 22(10):1345-1359, 2009.
[22] Fuzhen Zhuang, Zhiyuan Qi, Keyu Duan, Dongbo Xi, Yongchun Zhu, Hengshu Zhu, Hui Xiong, and Qing He. A comprehensive survey on transfer learning. arXiv preprint arXiv:1911.02685, 2019.
[23] Mingsheng Long, Yue Cao, Jianmin Wang, and Michael I Jordan. Learning transferable features with deep adaptation networks. arXiv preprint arXiv:1502.02791, 2015.
[24] Eric Tzeng, Judy Hoffman, Kate Saenko, and Trevor Darrell. Adversarial discriminative domain adaptation. In Proceedings of the IEEE Conference on Computer Vision and Pattern Recognition, pages 7167-7176, 2017.
[25] Judy Hoffman, Eric Tzeng, Taesung Park, Jun-Yan Zhu, Phillip Isola, Kate Saenko, Alexei A Efros, and Trevor Darrell. Cycada: Cycle-consistent adversarial domain adaptation. In International Conference on Machine Learning, 2018.
[26] Kuniaki Saito, Kohei Watanabe, Yoshitaka Ushiku, and Tatsuya Harada. Maximum classifier discrepancy for unsupervised domain adaptation. In Proceedings of the IEEE Conference on Computer Vision and Pattern Recognition, pages 3723-3732, 2018.
[27] Yuchen Zhang, Tianle Liu, Mingsheng Long, and Michael Jordan. Bridging theory and algorithm for domain adaptation. In Kamalika Chaudhuri and Ruslan Salakhutdinov, editors, Proceedings of the 36th International Conference on Machine Learning, volume 97 of Proceedings of Machine Learning Research, pages 7404-7413, Long Beach, California, USA, 09-15 Jun. 2019. PMLR.
[28] Boris Chidlovskii, Stephane Clinchant, and Gabriela Csurka. Domain adaptation in the absence of source domain data. In Proceedings of the 22nd ACM SIGKDD International Conference on Knowledge Discovery and Data Mining, pages 451-460, 2016.
[29] Jian Liang, Ran He, Zhenan Sun, and Tieniu Tan. Distant supervised centroid shift: A simple and efficient approach to visual domain adaptation. In Proceedings of the IEEE Conference on Computer Vision and Pattern Recognition, pages 2975-2984, 2019.
[30] Philip Bachman, R Devon Hjelm, and William Buchwalter. Learning representations by maximizing mutual information across views. In Advances in Neural Information Processing Systems, pages 15509-15519, 2019.
[31] Yves Grandvalet and Yoshua Bengio. Semi-supervised learning by entropy minimization. In Advances in neural information processing systems, pages 529-536, 2005.
[32] Kuniaki Saito, Donghyun Kim, Stan Sclaroff, Trevor Darrell, and Kate Saenko. Semi-supervised domain adaptation via minimax entropy. In Proceedings of the IEEE International Conference on Computer Vision, pages 8050-8058, 2019.
[33] Takeru Miayto, Andrew M Dai, and Ian Goodfellow. Virtual adversarial training for semi-supervised text classification. In International Conference on Learning Representations, 2017.
[34] Rui Shu, Hung H Bui, Hirokazu Narui, and Stefano Ermon. A dirt-t approach to unsupervised domain adaptation. In International Conference on Learning Representations, 2018.
[35] Abhishek Kumar, Prasanna Sattigeri, Kahini Wadhawan, Leonid Karlinsky, Rogerio Feris, Bill Freeman, and Gregory Wornell. Co-regularized alignment for unsupervised domain adaptation. In Advances in Neural Information Processing Systems, pages 9345-9356, 2018.
[36] Pietro Morerio, Jacopo Cavazza, and Vittorio Murino. Minimal-entropy correlation alignment for unsuper-vised deep domain adaptation. arXiv preprint arXiv:1711.10288, 2017.
[37] Sebastian Ruder. An overview of multi-task learning in deep neural networks. arXiv preprint arXiv:1706.05098, 2017.
[38] Yishay Mansour, Mehryar Mohri, and Afshin Rostamizadeh. Domain adaptation with multiple sources. In Advances in neural information processing systems, pages 1041-1048, 2009.
[39] Lixin Duan, Ivor W Tsang, Dong Xu, and Tat-Seng Chua. Domain adaptation from multiple sources via auxiliary classifiers. In Proceedings of the 26th Annual International Conference on Machine Learning, pages 289-296, 2009.
[40] Xingchao Peng, Qinxun Bai, Xide Xia, Zijun Huang, Kate Saenko, and Bo Wang. Moment matching for multi-source domain adaptation. In Proceedings of the IEEE International Conference on Computer Vision, pages 1406-1415, 2019.
[41] Stanislav Fort, Huiyi Hu, and Balaji Lakshminarayanan. Deep ensembles: A loss landscape perspective. arXiv preprint arXiv:1912.02757, 2019.
[42] Florian Tramer, Alexey Kurakin, Nicolas Papernot, Ian Goodfellow, Dan Boneh, and Patrick McDaniel. Ensemble adversarial training: Attacks and defenses. arXiv preprint arXiv:1705.07204, 2017.
[43] Pau Panareda Busto and Juergen Gall. Open set domain adaptation. In Proceedings of the IEEE Interna-tional Conference on Computer Vision, pages 754-763, 2017.
[44] Yarin Gal and Zoubin Ghahramani. Dropout as a bayesian approximation: Representing model uncertainty in deep learning. In international conference on machine learning, pages 1050-1059, 2016.
[45] Kate Saenko, Brian Kulis, Mario Fritz, and Trevor Darrell. Adapting visual category models to new domains. In European conference on computer vision, pages 213-226. Springer, 2010.
[46] Hemanth Venkateswara, Jose Eusebio, Shayok Chakraborty, and Sethuraman Panchanathan. Deep hashing network for unsupervised domain adaptation. In Proceedings of the IEEE Conference on Computer Vision and Pattern Recognition, pages 5018-5027, 2017.
[47] Xingchao Peng, Ben Usman, Neela Kaushik, Dequan Wang, Judy Hoffman, and Kate Saenko. Visda: A synthetic-to-real benchmark for visual domain adaptation. In Proceedings of the IEEE Conference on Computer Vision and Pattern Recognition Workshops, pages 2021-2026, 2018.
[48] Zhijie Deng, Yucen Luo, and Jun Zhu. Cluster alignment with a teacher for unsupervised domain adaptation. In Proceedings of the IEEE International Conference on Computer Vision, pages 9944-9953, 2019.
[49] Xinyang Chen, Sinan Wang, Mingsheng Long, and Jianmin Wang. Transferability vs. discriminability: Batch spectral penalization for adversarial domain adaptation. In International Conference on Machine Learning, pages 1081-1090, 2019.
[50] Ximei Wang, Ying Jin, Mingsheng Long, Jianmin Wang, and Michael I Jordan. Transferable normalization: Towards improving transferability of deep neural networks. In Advances in Neural Information Processing Systems, pages 1951-1961, 2019.
[51] Ruijia Xu, Guanbin Li, Jihan Yang, and Liang Lin. Larger norm more transferable: An adaptive feature norm approach for unsupervised domain adaptation. In Proceedings of the IEEE International Conference on Computer Vision, pages 1426-1435, 2019.
[52] Mingsheng Long, Han Zhu, Jianmin Wang, and Michael I Jordan. Deep transfer learning with joint adaptation networks. In Proceedings of the 34th International Conference on Machine Learning-Volume 70, pages 2208-2217. JMLR. org, 2017.
[53] Swami Sankaranarayanan, Yogesh Balaji, Carlos D Castillo, and Rama Chellappa. Generate to adapt: Aligning domains using generative adversarial networks. In Proceedings of the IEEE Conference on Computer Vision and Pattern Recognition, pages 8503-8512, 2018.
[54] Mingsheng Long, Zhangjie Cao, Jianmin Wang, and Michael I Jordan. Conditional adversarial domain adaptation. In Advances in Neural Information Processing Systems, pages 1640-1650, 2018.
[55] Morris H DeGroot and Stephen E Fienberg. The comparison and evaluation of forecasters. Journal of the Royal Statistical Society: Series D (The Statistician), 32(1-2):12-22, 1983.
[56] Alexandru Niculescu-Mizil and Rich Caruana. Predicting good probabilities with supervised learning. In Proceedings of the 22nd international conference on Machine learning, pages 625-632, 2005.
[57] Mandi Pakdaman Naeini, Gregory Cooper, and Milos Hauskrecht. Obtaining well calibrated probabilities using bayesian binning. In Twenty-Ninth AAAI Conference on Artificial Intelligence, 2015.
[58] Kaiming He, Xiangyu Zhang, Shaoqing Ren, and Jian Sun. Deep residual learning for image recognition. In Proceedings of the IEEE conference on computer vision and pattern recognition, pages 770-778, 2016.
[59] Olga Russakovsky, Jia Deng, Hao Su, Jonathan Krause, Sanjeev Satheesh, Sean Ma, Zhiheng Huang, Andrej Karpathy, Aditya Khosla, Michael Bernstein, et al. Imagenet large scale visual recognition challenge. International journal of computer vision, 115(3):211-252, 2015.
[60] Kuniaki Saito, Yoshitaka Ushiku, Tatsuya Harada, and Kate Saenko. Adversarial dropout regularization. arXiv preprint arXiv:1711.01575, 2017.
[61] Chen-Yu Lee, Tanmay Batra, Mohammad Haris Baig, and Daniel Ulbricht. Sliced wasserstein discrepancy for unsupervised domain adaptation. In Proceedings of the IEEE Conference on Computer Vision and Pattern Recognition, pages 10285-10295, 2019.

1. A method for training a set of trained models each comprising a common feature extractor by using an unlabelled training dataset to thereby obtain an updated common feature extractor, the method being executed by at least one processing device, the method comprising:
obtaining the set of trained models, each trained model of the set of trained models having the common feature extractor, each trained model of the set of trained models having been trained for a common prediction task during a supervised training phase on a labelled training dataset;
obtaining the unlabelled training dataset;
training, for the common prediction task, the set of trained models by using the obtained unlabelled training dataset to thereby obtain the updated common feature extractor, the training comprising:
generating, using the common feature extractor of the set of trained models, a set of feature vectors for at least a portion of the unlabelled training dataset;
generating, using the set of trained models, a set of predictions, the set of predictions comprising a respective prediction for each of the set of feature vectors; and
updating the common feature extractor, the updating comprising:
maximizing, for each given trained model of the set of trained models, a mutual information between the set of feature vectors and the respective predictions generated by the set of trained models.

2. (canceled)

3. The method of claim 1, wherein the common prediction task comprises one of: a regression task, and a classification task.

4. The method of claim 3, wherein said updating of the common feature extractor further comprises minimizing a dissimilarity measure between at least a given prediction of the set of predictions and at least one other given prediction of the set of predictions of the set of trained models.

5. The method of claim 4, further comprising, prior to said obtaining of the set of trained models: obtaining the labelled training dataset; initializing, based on a different respective condition, each initial model of a set of initial models for the common prediction task, each initial model comprising an initial common feature extractor; and training the set of initial models for the common prediction task during the supervised training phase on the labelled training dataset to obtain the set of trained models, each trained model of the set of trained models comprising the common feature extractor.

6. The method of claim 5, wherein said training of the set of initial models for the common prediction task during the supervised training phase on the labelled training dataset to obtain the set of trained models comprises: generating, using the set of initial models, a set of initial predictions for the labelled training dataset; and updating at least a portion of each of the set of initial models to obtain the set of trained models, the updating comprising: determining a respective loss for each of the set of initial predictions to obtain a set of losses.

7. The method of claim 6, wherein said updating of at least the portion of each of the set of initial models to obtain the set of trained models further comprises: determining an average loss based on the set of losses; and backpropagating the average loss to the at least the portion of the set of initial models.

8. The method of claim 7, wherein the labelled training dataset is associated with a first type of domain representation of a set of objects; and wherein the unlabelled training dataset is associated with a second type of domain representation of at least a portion of the set of objects.

9. The method of claim 8, wherein the labelled training dataset comprises labelled images; and wherein the unlabelled training dataset comprises unlabelled images.

10. The method of claim 1, wherein the labelled training dataset has been acquired using a first type of device; and wherein the unlabelled training dataset has been acquired using a second type of device.

11. The method of claim 1, further comprising using the updated common feature extractor to extract features from data in a radiomics process.

12-14. (canceled)

15. A system for training a set of trained models each comprising a common feature extractor by using an unlabelled training dataset to thereby obtain an updated common feature extractor, the system comprising:
a processor; and
a non-transitory storage medium operatively connected to the processor, the non-transitory storage medium comprising computer-readable instructions;
the processor, upon executing the instructions, being configured for:
obtaining the set of trained models, each trained model of the set of trained models having the common feature extractor, each trained model of the set of trained models having been trained for a common prediction task during a supervised training phase on a labelled training dataset;
obtaining the unlabelled training dataset;
training, for the common prediction task, the set of trained models by using the obtained unlabelled training dataset to thereby obtain the updated common feature extractor, the training comprising:
generating, using the common feature extractor of the set of trained models, a set of feature vectors for at least a portion of the unlabelled training dataset;
generating, using the set of trained models, a set of predictions, the set of predictions comprising a respective prediction for each of the set of feature vectors; and
updating the common feature extractor, the updating comprising:
maximizing, for each given trained model of the set of trained models, a mutual information between the set of feature vectors and the respective predictions generated by the set of trained models.

16. (canceled)

17. The system of claim 15, wherein the common prediction task comprises one of: a regression task, and a classification task.

18. The system of to claim 17, wherein said updating of the common feature extractor further comprises minimizing a dissimilarity measure between at least a given prediction of the set of predictions and at least one other given prediction of the set of predictions of the set of trained models.

19. The system of to claim 18, wherein the processor is further configured for, prior to said obtaining of the set of trained models: obtaining the labelled training dataset; initializing, based on a different respective condition, each initial model of a set of initial models for the common prediction task, each initial model comprising an initial common feature extractor; and training the set of initial models for the common prediction task during the supervised training phase on the labelled training dataset to obtain the set of trained models, each trained model of the set of trained models comprising the common feature extractor.

20. The system of claim 19, wherein said training of the set of initial models for the common prediction task during the supervised training phase on the labelled training dataset to obtain the set of trained models comprises: generating, using the set of initial models, a set of initial predictions for the labelled training dataset; and updating at least a portion of each of the set of initial models to obtain the set of trained models, the updating comprising: determining a respective loss for each of the set of initial predictions to obtain a set of losses.

21. The system of claim 19, wherein said updating of at least the portion of each of the set of initial models to obtain the set of trained models further comprises: determining an average loss based on the set of losses; and backpropagating the average loss to the at least the portion of the set of initial models.

22. The system of claim 15, wherein the labelled training dataset is associated with a first type of domain representation of a set of objects; and wherein the unlabelled training dataset is associated with a second type of domain representation of at least a portion of the set of objects.

23. The system of claim 15, wherein the labelled training dataset comprises labelled images; and wherein the unlabelled training dataset comprises unlabelled images.

24. (canceled)

25. The system of claim 15, wherein the processor is further configured for using the updated common feature extractor to extract features from data in a radiomics process.

26-27. (canceled)

28. A method of providing a final trained model by training a set of trained models each comprising a common feature extractor by using an unlabelled training dataset to thereby obtain an updated common feature extractor, the method being executed by at least one processing device, the method comprising:
obtaining the set of trained models, each trained model of the set of trained models having the common feature extractor, each trained model of the set of trained models having been trained for a common prediction task during a supervised training phase on a labelled training dataset;
obtaining the unlabelled training dataset;
training, for the common prediction task, the set of trained models by using the obtained unlabelled training dataset to thereby obtain the updated common feature extractor, the training comprising:
generating, using the common feature extractor of the set of trained models, a set of feature vectors for at least a portion of the unlabelled training dataset;
generating, using the set of trained models, a set of predictions, the set of predictions comprising a respective prediction for each of the set of feature vectors; and
updating the common feature extractor, the updating comprising:
maximizing, for each given trained model of the set of trained models, a mutual information between the set of feature vectors and the respective predictions generated by the set of trained models; and
providing, using the set of trained models and the updated common feature extractor, the final trained model.
